(19) United States
(12) Patent Application Publication
(10) Pub. No.: US 2009/0297869 A1
(43) Pub. Date: Dec. 3, 2009

(54) BONDING METHOD AND BONDED BODY

(75) Inventor: Kazuhiro GOMI, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/474,290

(22) Filed: May 29, 2009

(30) Foreign Application Priority Data
Jun. 3, 2008 (JP) 2008-145877

(51) Int. Cl. B32B 27/04; B32B 37/12

(52) U.S. Cl. 428/448; 156/272.2

(57) ABSTRACT

A bonding method includes: preparing a first substrate and a second substrate; forming a liquid coating film by applying a liquid material including silicone to at least one of the first substrate and the second substrate; drying the liquid coating film so as to obtain a bonding film; and developing adhesiveness around a surface of the bonding film by applying energy to the bonding film so as to obtain a bonded body obtained by bonding the first substrate and the second substrate each other with the bonding film interposed between the first substrate and the second substrate. In the device, bonding strength of the bonding film is adjusted by appropriately setting a condition for applying the energy.

The entire disclosure of Japanese Patent Application No. 2008-145877, filed Jun. 3, 2008 is expressly incorporated by reference herein.

### BACKGROUND

1. Technical Field

The present invention relates to a bonding method and a bonded body.

2. Related Art

When two members (substrates) are bonded (glued) each other, conventionally, methods using adhesives such as an epoxy adhesive, an urethane adhesive, and a silicone adhesive are often employed. The adhesives can exhibit adhesiveness regardless of the materials of the members. Therefore, members made of various materials can be bonded each other in different combinations. For example, a droplet discharge head (an inkjet recording head) included in an inkjet printer is composed by bonding members made of different materials such as resin material, metal material, and silicon material with an adhesive (JP-A-5-155017 is an example of related art).

When the members are bonded with an adhesive, a liquid adhesive or a pasty adhesive is applied on a bond surface so as to bond the members together with the applied adhesive interposed therebetween. Thereafter, the adhesive is hardened by effect of heat or light so as to bond the members together. However, the adhesive has the following problems: low in bonding strength, so that hard to adjust the bonding strength; low in dimensional accuracy; and it takes a long time to bond due to a long hardening time.

Further, in many cases, using a primer is required for improving the bonding strength. Therefore, costs and troubles due to using the primer result in increasing the costs and the complexity of the bonding process. Furthermore, especially, when adjusting the bonding strength with an adhesive, selection of the material of the adhesive and mixing adhesives having different adhesiveness are required. As a result, it is difficult to obtain desired bonding strength.

### SUMMARY

An advantage of the invention is to provide a bonding method in which members can be efficiently bonded with high dimensional accuracy while its bonding strength is adjusted regardless of the materials used for the bond, and a bonded body obtained by bonding the members each other with high dimensional accuracy and adjusted bonding strength.

According to a first aspect of the invention, a bonding method includes: preparing a first substrate and a second substrate; forming a liquid coating film by applying a liquid material including silicone to at least one of the first substrate and the second substrate; drying the liquid coating film so as to obtain a bonding film; and developing adhesiveness around a surface of the bonding film by applying energy to the bonding film so as to obtain a bonded body obtained by bonding the first substrate and the second substrate each other with the bonding film interposed between the first substrate and the second substrate. In the device, bonding strength of the bonding film is adjusted by appropriately setting a condition for applying the energy. Accordingly, the bonding method in which members can be efficiently bonded with high dimensional accuracy while its bonding strength is adjusted regardless of the material used for the bond is provided.

In the bonding method of the invention, the condition is preferably set by adjusting an amount of energy applied to the bonding film. Thus, the bonding strength of the bonded body can be easily adjusted. In the bonding method of the invention, the energy is preferably applied by at least one out of irradiating the bonding film with an energy ray, heating the bonding film, and applying a pressure on the bonding film so as to set the condition. This enables a surface of the bonding film to be efficiently activated so as to easily control the bonding strength of the bonding film. Additionally, since a molecular structure of the bonding film is not cleaved more than necessary, degrading a characteristic of the bonding film can be avoided.

In the bonding method of the invention, the energy ray is preferably an ultraviolet ray having a wavelength from 126 nm to 300 nm. The ultraviolet ray within the range allows an amount of applied energy to be optimized. Therefore, the molecular bond serving as a skeleton of the bonding film can be prevented from being destroyed more than necessary, and a molecular bond existing from the bonding film to around the surface can be selectively cleaved. Accordingly, characteristics (a mechanical characteristic, a chemical characteristic, and the like) of the bonding film can be prevented from being degraded, and adhesiveness of the bonding film can be surely developed, thereby allowing controlling the adhesiveness of the bonding film more easily.

In the bonding method of the invention, the energy is preferably applied in an ambient atmosphere. Accordingly, activation of the surface of the bonding film is performed more smoothly, whereby easily controlling the bonding strength of the bonding film. Further, without any trouble and cost for controlling an atmosphere, the application of energy can be more easily performed.

In the bonding method of the invention, in a plan view, the energy is preferably applied to the bonding film positioned at a first region and the bonding film positioned at a second region that is different from the first region under a different condition so that the bonding film positioned at the first region and the second region have different bonding strength. Accordingly, since the bonding film positioned at the first region and the bonding film positioned at the second region have different bonding strength, the bonding strength of the bonding film as a whole can be easily adjusted.

In the bonding method of the invention, the energy is preferably applied to the bonding film multiple times. Since the energy is applied to the bonding film multiple times, an amount of energy applied to the bonding film can be adjusted with higher accuracy. Furthermore, with respect to each region of the bonding film, the energy is more easily applied under a different condition.

The bonding method of the invention preferably further includes selectively applying the energy to the bonding film positioned at the first region; bringing the first substrate and the second substrate into contact with each other with the bonding film interposed between the first substrate and the second substrate; and applying the energy to the bonding film positioned at the first region and the second region. Accordingly, since the bonding film positioned at the first region and the bonding film positioned at the second region have different amount and condition of energy applied, the bonded body having different bonding strength can be easily obtained.

The bonding method of the invention preferably further includes applying the energy to the bonding film positioned at the first region and the second region; bringing the first substrate and the second substrate into contact with each other with the bonding film interposed between the first substrate and the second substrate; and selectively applying the energy to the bonding film positioned at the first region. Accordingly, since the bonding film positioned at the first region and the second region have different amount and condition of energy applied, the bonded body having different bonding strength can be easily obtained.

In the bonding method of the invention, the silicone preferably includes a silanol group. Accordingly, when the bonding film is obtained by drying the liquid coating film, hydroxyl groups included in the adjacent silicone materials are bonded each other. Therefore, the obtained bonding film has superior film strength. In the bonding method of the invention, the silicone material preferably includes a phenyl group bonded to a silicon atom having a silanol group. Accordingly, when the bonding film is obtained by drying the liquid coating film, reactivity of the silanol group is further improved, and the bond of the hydroxyl groups included in the adjacent silicone materials are more smoothly performed. Therefore, the obtained bonding film has superior film strength.

In the bonding of the invention, the bonded body is preferably obtained by bringing the first substrate and the second substrate into contact with each other with the bonding film interposed between the first substrate and the second substrate after the energy is applied to the bonding film so as to develop adhesiveness around a surface of the bonding film. Accordingly, the bonding method in which members can be efficiently bonded with high dimensional accuracy while bonding strength is adjusted regardless of the materials used for the bond is provided.

In the bonding of the invention, the bonded body is preferably obtained by applying the energy to the bonding film after bringing the first substrate and the second substrate into contact with each other with the bonding film interposed between the first substrate and the second substrate. Accordingly, the bonding method in which members can be efficiently bonded with high dimensional accuracy while bonding strength is adjusted regardless of the material used for the bond is provided.

In the bonding method of the invention, the liquid coating film is preferably formed by a droplet discharge method. According to the droplet discharge method, since the liquid material can be supplied as droplets on a bond surface, even if the liquid coating film is selectively patterned on a part of the region of the bond surface, the liquid material can be supplied in accordance with a shape of the region (selectively on the region).

In the bonding method of the invention, an average thickness of the bonding film is preferably 10 nm to 10000 nm. Setting the average thickness of the formed bonding film in the range prevents a significant decrease in dimensional accuracy of the bonded body obtained by bonding the first substrate and the second substrate. Further, by appropriately setting a condition for applying energy, bonding strength of the bonding film can be more easily controlled.

In the bonding method of the invention, at least a part of the first substrate and the second substrate contacting the bonding film is preferably made of silicon, metal, or glass as a main material. The second substrate made of the above material has a surface covered with an oxide film having a hydroxyl group bonded to (exposed on) the film surface, whereby desired bonding strength between the bond surface of the second substrate and the bonding film can be more surely obtained.

In the bonding method of the invention, a surface of the first substrate and the second substrate contacting the bonding film is preferably surface-treated in advance so as to increase adhesiveness to the bonding film. Accordingly, when the bonding film is formed on the bond surface, the bond surface and the bonding film can be strongly bonded, so that the obtained bonded body has high reliability.

In the bonding method of the invention, the surface treatment includes a plasma treatment or a UV radiation treatment. The plasma treatment or the UV radiation treatment is performed as a surface treatment so that the bond surface is cleaned and activated. As a result, the bond surface and the bonding film can be more strongly bonded.

According to a second aspect of the invention, a bonded body includes: a bonding film formed by the bonding method described above so as to bond the first substrate and the second substrate with the bonding film interposed between the first substrate and the second substrate. Thus, the bonded body obtained by bonding the members each other with high dimensional accuracy and adjusted bonding strength can be provided.

### BRIEF DESCRIPTION OF THE DRAWINGS

The invention will be described with reference to the accompanying drawings, wherein like numbers reference like elements.

FIGS. 1A, 1B, 1C, and 1D are diagrams (vertical sectional diagrams) explaining a first embodiment of a bonding method of the invention.

FIGS. 2E, 2F, and 2G are diagrams (vertical sectional diagrams) explaining the first embodiment of the bonding method of the invention.

FIGS. 3A and 3B are plan views showing a pattern of energy applied on a bonding film in the bonding method of the invention.

FIGS. 4A and 4B are diagrams (vertical sectional diagrams) explaining a second embodiment of the bonding method of the invention.

FIGS. 5C, 5D, and 5E are diagrams (vertical sectional diagrams) explaining the second embodiment of the bonding method of the invention.

FIG. 6 is a sectional view showing a lithium ion secondary battery manufactured by using the bonding method of the invention.

FIG. 7 is a diagram (a cross sectional view) schematically showing a preferred embodiment of an organic luminescent device (a passive matrix type display) to which the bonding method of the invention is applied.

FIG. 8 is a plan view explaining a pattern of anodes and cathodes included in the organic luminescent device shown in FIG. 7.

FIG. 9 is a plan view explaining an arrangement pattern of organic EL elements included in the organic luminescent device shown in FIGS. 7 and 8.

FIG. 10 is a plan view schematically showing another arrangement pattern of the organic EL elements.

### DESCRIPTION OF EXEMPLARY EMBODIMENTS

A bonding method and a bonded body of the invention will now be described in detail based on preferred embodiments with reference to the accompanying drawings.

Bonding Method

In the bonding method of the invention, a first substrate 21 and a second substrate 22 are bonded each other with a bonding film 3 interposed therebetween. Specifically, the bonding method of the invention includes a step of obtaining a bonding film and a step of obtaining a bonded body. In the step of obtaining a bonding film, first, a first substrate and a second substrate are prepared. A liquid material including silicone is applied to at least one of the first substrate and the second substrate so as to form a liquid coating film. Then, the liquid coating film is dried so as to obtain the bonding film. In the step of obtaining a bonded body, energy is applied to the bonding film so as to develop adhesiveness around a surface of the bonding film. Then, the first and the second substrates are bonded each other with the bonding film interposed therebetween so as to obtain the bonded body. Appropriately setting conditions for applying energy allows the adhesiveness of the bonding film 3 to be adjusted. In other words, the energy corresponding to obtaining the adhesiveness required for each region of the bonding film 3 is applied to each region of the bonding film 3, so that the adhesiveness of the bonding film 3 is adjusted.

According to the method, the adhesiveness developed around the surface of the bonding film 3 made of silicone enables the two substrates 21 and 22 to be bonded each other with high dimensional accuracy. In addition, the bonding film 3 made of silicone essentially can develop high adhesiveness by sufficiently applying energy as described later. By appropriately setting conditions for applying energy when the energy is applied to the bonding film 3, bonding strength of the bonding film 3 can be adjusted to desired strength, whereby the obtained bonded body 1 has the desired bonding strength. Further, the two substrates 21 and 22 can be efficiently bonded with the bonding film 3 interposed therebetween under low temperature. Hereinafter, a first embodiment of the bonding method of the invention will be described by each step.

### First Embodiment

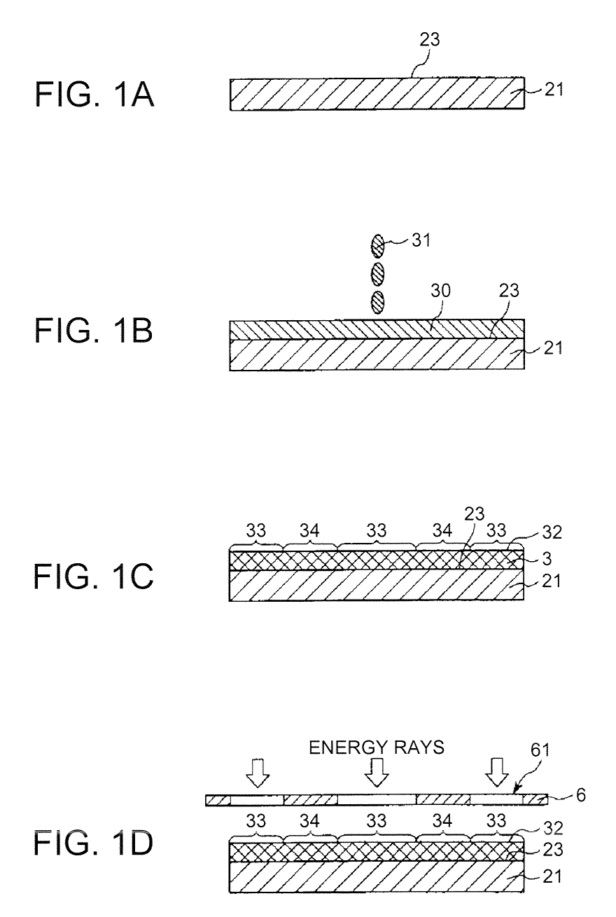

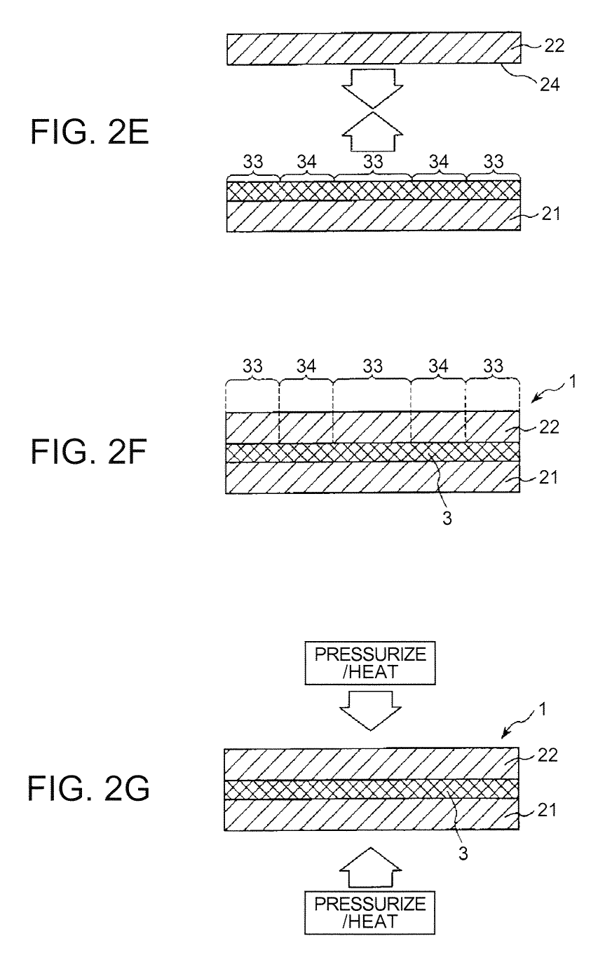

FIGS. 1A, 1B, 1C, 1D, 2E, 2F, and 2G are diagrams (vertical sectional diagrams) for explaining the first embodiment exemplifying the bonding method of the invention. Note that the top side of FIGS. 1A to 2G is referred to as “up” and the bottom side thereof is referred to as “down” in the following descriptions. In the bonding method of the present embodiment, the bonding film 3 is selectively formed on the first substrate 21 without being formed on the second substrate 22. Then, the first substrate 21 and the second substrate 22 are bonded together with the bonding film 3 interposed therebetween.

At a step 1, first, the first substrate 21 and the second substrate 22 are prepared. In FIG. 1A, the second substrate 22 is omitted. A constituent material of the first substrate 21 and the second substrate 22 is not particularly limited. Examples of the material include polyolefins such as polyethylene, polypropylene, ethylene-propylene copolymer, ethylene-acrylic acid ester copolymer, ethylene-acrylic acid copolymer, polybutene-1, ethylene-vinyl acetate copolymer (EVA); polyesters such as cyclic polyolefin, modified polyolefin, polyvinyl chloride, polyvinylidene chloride, polystyrene, polyamide, polyimide, polyamideimide, polycarbonate, poly-(4-methylpentene-1), ionomer, acrylic resin, polymethyl methacrylate (PMMA), acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polyethylene naphthalate, polybutylene terephthalate (PBT), polycyclohexane terephthalate (PCT); various thermoplastic elastomers such as polyether, polyether ketone (PEK), polyether ether ketone (PEEK), polyetherimide, polyacetal (POM), polyphenylene oxide, modified polyphenylene oxide, polysulfone, polyethersulfone, polyphenylene sulfide, polyalylate, aromatic polyester (liquid crystal polymer), polytetrafluoroethylene, polyvinylidene fluoride, other fluorine resin, styrene series, polyolefin series, polyvinylchloride series, polyurethane series, polyester series, polyamide series, polybutadiene series, transpolyisoprene series, fluororubber series, chlorinated polyethylene series; resin materials such as epoxy resin, phenol resin, urea resin, melanin resin, aramid resin, unsaturated polyester, silicone resin, polyurethane, copolymers, blended materials, or polymer alloys that primarily contain the above materials; metals such Fe, Ni, Co, Cr, Mn, Zn, Pt, Au, Ag, Cu, Pd, Al, W, Ti, V, Mo, Nb, Zr, Pr, Nd, Sm; alloys including these metals; metallic materials such as carbon steel, stainless steel, indium-tin oxide (ITO), gallium arsenide; silicon materials such as monocrystalline silicon, polycrystalline silicon, and amorphous silicon; glass materials such as silicate glass (quartz glass), alkali silicate glass, soda-lime glass, potash-lime glass, lead (alkali) glass, barium glass, and borosilicate glass; ceramics such as alumina, zirconia, MgAl₂O₄, ferrite, silicon nitride, aluminum nitride, boron nitride, titanium nitride, silicon carbide, boron carbide, titanium carbide, and tungsten carbide; carbons such as graphite; and composite materials formed by combining one or more kinds of those materials.

In addition, a surface of each of the first substrate 21 and the second substrate 22 may be subjected to a plating treatment such as Ni plating, a passivation treatment such as chromating, a nitriding treatment, or the like. The first substrate 21 and the second substrate 22 may be made of the same material or a different material.

Further, the first substrate 21 and the second substrate 22 preferably have approximately the same coefficient of thermal expansion. If the substrates 21 and 22 have approximately the same thermal expansion rate, when the first and the second substrates are bonded each other, stress due to thermal expansion on a bonded interface hardly occurs. As a result, undesired separation between the substrates in the finally obtained bonded body 1 can be surely prevented. In addition, as described later, even if the first substrate 21 and the second substrate 22 have a different thermal expansion rate, by optimizing conditions for bonding the first substrate 21 and the second substrate 22 in a step described later, the substrates can be bonded with high dimensional accuracy while its bonding strength between the first substrate 21 and the second substrate 22 with the bonding film 3 interposed therebetween is adjusted so as to obtain the desired bonding strength.

Preferably, the two substrates 21 and 22 have a different rigidity. This allows the two substrates 21 and 22 to be substantially adhered closely to each other so as to be more strongly bonded. In addition, a constituent material of at least one of the two substrates 21 and 22 is preferably a resin. The flexibility of resin allows reducing stress (for example, stress due to thermal expansion) occurring on the bonded interface between the two substrates 21 and 22 bonded together. Accordingly, the bonded interface becomes hard to be damaged and thereby the bonding strength is suppressed from being lowered by the stress.

According to the viewpoint described above, at least one of the two substrates 21 and 22 preferably is flexible. This allows preventing the bonding strength from being lowered by the stress occurring on the bonded interface of the bonded body 1. In addition, if the two substrates 21 and 22 are both flexible, the obtained bonded body 1 as a whole is flexible and highly functional.

It is only necessary for each of the substrates 21 and 22 to have a surface supporting the bonding film 3. For example, the substrate may be plate-shaped (layer-shaped), block-shaped, or bar-shaped. The present embodiment employs the plate-shaped substrates 21 and 22 as shown in FIGS. 1A to 2G. This allows each of the substrates 21 and 22 to be easily bended. Therefore, when the two substrates 21 and 22 are bonded each other, they are substantially deformed along each other's shape. Accordingly, adhesiveness of the two substrates 21 and 22 when they are bonded each other is increased, and desired bonding strength of the finally obtained bonded body 1 is more easily and surely obtained. Therefore, the bonded body 1 with high reliability is achieved. Additionally, flexion of each of the substrates 21 and 22 can serve to reduce stress occurring on the bonded interface to some extent. In this case, an average thickness of each of the substrates 21 and 22 is not particularly limited, but preferably approximately from 0.01 mm to 10 mm, and more preferably approximately from 0.1 mm to 3 mm.

Next, if necessary, a surface treatment is performed so as to increase adhesiveness with respect to the bonding film 3 to be formed on a bond surface 23 of the first substrate 21. The treatment cleans and activates the bond surface 23, thereby chemically increasing the adhesiveness of the bonding film 3 with respect to the bond surface 23. As a result, in a step described later, when the bonding film 3 is formed on the bond surface 23, the bond surface 23 and the bonding film 3 can be more strongly bonded, so that the obtained bonded body 1 has high reliability.

The surface treatment is not specifically limited, but may be a physical surface treatment such as sputtering treatment or blast treatment, a plasma treatment using oxygen plasma or nitrogen plasma, a chemical surface treatment such as corona discharge, etching, electron beam radiation, UV radiation, ozone exposure, or a combination of those treatments. If the first substrate 21 subjected to the surface treatment is made of a resin material (a polymeric material), especially the corona discharge treatment, the nitrogen plasma treatment, or the like are preferably used.

Further, the plasma treatment or the UV radiation treatment is performed as a surface treatment so that the bond surface 23 is cleaned and activated. As a result, the bond surface 23 and the bonding film 3 is more strongly bonded. Depending on the material of the first substrate 21, without the above surface treatment, the bonding strength between the bond surface 23 and the bonding film 3 is sufficiently increased. Examples of such an effective material for the substrate 21 include materials mainly containing the above-described various metal materials, silicon materials, and glass materials.

The first substrate 21 made of any of the above materials has a surface covered with an oxide film having a hydroxyl group bonded to the surface of the oxide film. Using the first substrate 21 having the surface covered with the oxide film, without performing the surface treatment as above, the bond surface 23 of the first substrate 21 and the bonding film 3 can be more strongly bonded. Alternatively, instead of the surface treatment, an intermediate layer may be formed in advance on the bond surface 23 of the first substrate 21.

The intermediate layer may have any function, and for example, preferably has a function of increasing the adhesiveness with the bonding film 3, a cushioning function (a buffer function), a function of reducing stress concentration, and the like. As a result, forming the bonding film 3 on the intermediate layer as above, finally, allows the bonded body 1 to be highly reliable. Examples of a material for the intermediate layer include metal materials such as aluminum and titanium; oxide materials such as a metal oxide and a silicon oxide; nitride materials such as a metal nitride and a silicon nitride; carbon materials such as a graphite and a diamond like carbon; self-assembled film materials such as a silane coupling agent, a thiol compound, a metal alkoxide; and a metal-halogen compound, and resin materials such a resin adhesive, a resin film, a resin coating material, various rubber materials, and various elastomers. One kind of these or a combination of two or more kinds of these may be used as a material for the intermediate layer. Among these materials, particularly, using the oxide materials for the intermediate layer can further increase the bonding strength between the first substrate 21 and the bonding film 3.

Meanwhile, similarly to the first substrate 21, also a bond surface 24 of the second substrate 22 (a surface of the second substrate 24 adhering closely to the bonding film 3 in a step described later) may be subjected to a surface treatment in advance, if necessary, to increase its adhesiveness with respect to the bonding film 3. The surface treatment cleans and activates the bond surface 24. As a result, in a step described later, when the bond surface 24 and the bonding film 3 are adhesively bonded each other, desired bonding strength can be surely obtained.

The surface treatment for the bond surface 24 is not particularly limited, but may be the same as that on the bond surface 23 of the first substrate 21. In addition, similarly to the first substrate 21, depending on the material for the second substrate 22, the adhesiveness with the bonding film 3 is sufficiently increased without the surface treatment as above. Examples of such an effective material for the substrate 22 mainly include the various metal materials, silicon materials, and glass materials described above.

The second substrate 22 made of the above material has a surface covered with an oxide film having a hydroxyl group bonded to (exposed on) the surface of the oxide film. Using the second substrate 22 having the surface covered with the oxide film, desired bonding strength between the bond surface 24 of the second substrate 22 and the bonding film 3 can be more surely obtained without performing the surface treatment as above.

In this case, an entire region of the second substrate 22 may not necessarily be made of any one of the materials above. However, at least in a region to be bonded to the bonding film 3, it is only necessary that a vicinity of the bond surface 24 is made of any one of the materials. In case where the bond surface 24 of the second substrate 22 includes a group or a material described below, desired bonding strength between the bond surface 24 of the second substrate 22 and the bonding film 3 can be more surely obtained without performing the surface treatment as above.

Examples of the group or the material includes: various functional groups such as a hydroxyl group, a thiol group, a carboxyl group, an amino group, a nitro group, and an imidazole group; various radicals; leaving intermediate molecules having ring-opening molecules or unsaturated bonds such as double bond and triple bond; and halogens such as F, Cl, Br, I; and dangling bonds (hands not terminated) produced when the groups are desorbed. At least one of them can be employed.

The leaving intermediate molecule preferably is a hydrocarbon molecule having the ring-opening molecule or the unsaturated bond. The hydrocarbon molecule strongly acts with respect to the bonding film 3 based on a significant reactivity of the ring-opening molecule and the unsaturated bond. Therefore, the bond surface 24 including such the hydrocarbon molecule can be strongly bonded to the bonding film 3. Additionally, the functional group included in the bond surface 24 is especially preferably a hydroxyl group. This allows the bond surface 24 to be especially easily and strongly bonded to the bonding film 3. Specifically, in a case where the hydroxyl group is exposed on the surface of the bonding film 3, a space between the bond surface 24 and the bonding film 3 can be bonded with high intensity based on a hydrogen bond occurring between the hydroxyl groups.

In addition to appropriately setting conditions for applying energy to the bond film described later, in order to have such the group or the material, it is preferable to perform an appropriately selected surface treatment among the various surface treatments described above with respect to the bond surface 24. This allows the second substrate 22 to be more easily bonded to the bonding film 3 with desired bonding strength. Specifically, for example, appropriately setting density of the group or the material described above at the bond surface 24 (selecting the material or its composition of a part exposed on the bond surface 24 of the second substrate 22) allows the second substrate 22 to be more easily bonded to the bonding film 3 with desired bonding strength.

The bond surface 24 of the second substrate 22 preferably includes the hydroxyl group. The bond surface 24 includes an attraction force generated based on the hydrogen bond between the bonding film 3 on which the hydroxyl group is exposed. Accordingly, finally, the first substrate 21 and the second substrate 22 can be especially strongly bonded each other. Alternatively, instead of the surface treatment, the intermediate layer may be formed in advance on the bond surface 24 of the second substrate 22.

The intermediate layer may have any function, and for example, similarly to the first substrate 21, preferably has a function of increasing the adhesiveness with the bonding film 3, a cushioning function (a buffer function), a function of reducing stress concentration, and the like. Then, bonding the second substrate 22 to the bonding film 3 with the intermediate layer interposed therebetween, finally, allows the bonded body 1 to be highly reliable. For example, the intermediate layer as above can be made of the same material as that of the intermediate layer on the bond surface 23 of the first substrate 21. The surface treatment and the formation of the intermediate layer as above are performed according to need and can be omitted if any high bonding strength is not particularly needed.

At a step 2, next, the liquid material including silicone is supplied on the bond surface 23 by using an application method. Accordingly, a liquid coating film 30 is formed on the bond surface 23 of the first substrate 21 (refer to FIG. 1B). The application method is not specifically limited. Examples of the application method includes a spin coating method, a casting method, a micro gravure coating method, a gravure coating method, a bar coating method, a roller coating method, a wire bar coating method, a dip coating method, a spray coating method, a screen printing method, a flexographic printing method, an offset printing method, a micro-contact printing method, a droplet discharge method, and the like. Specifically, the droplet discharge method is preferably used. Using the droplet discharge method, as shown in FIG. 1B, allows the liquid material to be supplied as droplets 31 on the bond surface 23. Accordingly, even if the liquid coating film 30 is selectively patterned on a part of the region of the bond surface 23, the liquid material can be supplied (selectively) in accordance with a shape of the region.

The droplet discharge method is not particularly limited. However, an inkjet method discharging the liquid material by using vibrations of piezoelectric elements is preferably used. Using the inkjet method allows the liquid material to be supplied as the droplets 31 with high positional precision on an intended region (position). In addition, appropriately setting the number of vibrations of the piezoelectric elements, a viscosity of the liquid material, and the like allows a size of the droplet 31 to be relatively easily adjusted. Thus, if the size of the droplet 31 is small, the liquid coating film 30 corresponding to a shape of the region can be surely formed even if the film formation region has a minute shape.

A viscosity of the liquid material (at 25° C.) is preferably approximately from 0.5 mPa·s to 200 mPa·s, and more preferably approximately from 3 mPa·s to 20 mPa·s. If the viscosity of the liquid material is within the range, droplets can be more stably discharged. Furthermore, when drying the liquid coating film 30 made of the liquid material at a step 3 below, the liquid material can contain an enough amount of the silicone material to form the bonding film 3. Even if the formed liquid coating film 30 has a minute shape, the droplet 31 having a size that can draw accurately is discharged.

If the viscosity of the liquid material is within the range, specifically, an amount of each droplet 31 (an amount of a single droplet of the liquid material) can be set, on an average, in a range of approximately 0.1 pL to 40 pL, and more practically in a range of approximately 1 pL to 30 pL. This allows a landed diameter of the droplet 31 supplied on the bond surface 23 to be small, whereby the bonding film 3 having the minute shape can be surely formed. Furthermore, by appropriately setting the amount of the droplet 31 supplied on the bond surface 23, a thickness of the bonding film 3 to be formed is relatively easily controlled.

The liquid material discharged as the droplets 31 includes silicone as described above. However, if the silicone material itself is a liquid and has a viscosity in the range above, the silicone material can be used as a liquid material as it is. If the silicone material itself is a solid or a liquid of high viscosity, a solution or a dispersion liquid of the silicone material is used as a liquid material.

Examples of a solvent or a dispersion medium for dissolving or dispersing the silicone material include inorganic solvents such as ammonia, water, hydrogen peroxide, carbon tetrachloride, and ethylene carbonate; ketone solvents such as methyl ethyl ketone (MEK) and acetone; alcohol solvents such as methanol, ethanol, and isobutanol; ether solvents such as diethyl ether and diisopropyl ether; cellosolve solvents such as methyl cellosolve; aliphatic hydrocarbon solvents such as hexane and pentane; aromatic hydrocarbon solvents such as toluene, xylene, and benzene; aromatic heterocyclic solvents such as pyridine, pyrazine, and furan; amido solvents such as N,N-dimethylformamide (DMF), halogen solvents such as dichloromethane and chloroform; ester solvents such as ethyl acetate and methyl acetate; sulfur compound solvents such as dimethylsulfoxide (DMSO) and sulfolane; nitrile solvents such as acetonitrile, propionitrile, and acrylonitrile; various organic solvents such as organic acid solvents including formic acid and trifluoroacetic acid; and mixtures of the solvents mentioned above.

The silicone material included in the liquid material is a main material of the bonding film 3 formed by drying the liquid material in a step 3 below. Here, the “silicone material” is a compound having a polyorganosiloxane skeleton. It usually is a compound having a main skeleton (a main chain) mainly formed by repeated organosiloxane units. It may be a branched structure projecting from a part of the main chain, a cyclic body that the main chain is circularly formed, or a linear-chain that the opposite terminals of the main chain are not linked to each other. For example, in the compound having the polyorganosiloxane skeleton, the organosiloxane unit includes a structural unit expressed by a following general formula (1) at a terminal portion, a structural unit expressed by a following general formula (2) at a linking portion, and a structural unit expressed by a following general formula (3) at a branched portion.

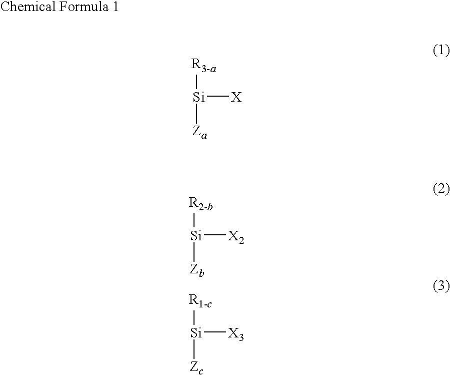

[In the formula, each R independently represents a substituted or a non-substituted hydrocarbon group; each Z independently represents a hydroxyl group or a hydrolysis group; each X represents a siloxane residue; a represents 0 or an integer of 1 to 3; b represents 0 or an integer of 1 or 2; and c represents 0 or 1.]

The siloxane residue is bonded to a silicon atom included in an adjacent structure unit through an oxygen atom, and represents a substituent forming a siloxane bond. Specifically, the siloxane-residue has —O—(Si) structure (Si is the silicon atom included in the adjacent structure unit). In the silicone material, the polyorganosiloxane skeleton preferably has a branched structure, which is composed of the structural unit expressed by the general formula (1), the structural unit expressed by the general formula (2), and the structural unit expressed by the general formula (3). The compound having the branched polyorganosiloxane skeleton (hereinafter, may be referred to as a “branched compound”) has a main skeleton (a mina chain) mainly formed by repeated organosiloxane units, where the repetition of the organosiloxane units is branched at a halfway portion of the main chain and opposite terminals of the main chain are not linked to each other.

Using the branched compound allows the bonding film 3 to be formed such that branched chains of the compound included in the liquid material are entangled to each other in the step 3 below. Therefore, the obtained bonding film 3 especially has superior film strength. In the above general formulas (1) to (3), examples of a group indicated by R (the substituted or the non-substituted hydrocarbon group) includes alkyl groups such as a methyl group, an ethyl group, and a propyl group; cycloalkyl groups such as a cyclopentyl group and a cyclohexyl group; aryl groups such as a phenyl group, a tolyl group, and biphenyl group; and aralkyl groups such as a benzyl group and a phenyl ethyl group. Further, examples of a part of or all of hydrogen atoms bonded to the carbon atom of the groups above include halogen atoms such as a fluorine atom, a chlorine atom, and a bromine atom; epoxy groups such as a glycidoxypropyl group; (meta)acrylyl groups such as a methacryl group; and groups substituted by anionic groups such as a carboxyl group and a sulfonyl group.

Examples of the hydrolysis group include alkoxy groups such as a methoxy group, an ethoxy group, a propoxy group, and a butoxy group; ketoxime groups such as a dimethyl ketoxime group and a methylethyl ketoxime group; acyl-oxy groups such as an acetoxy group; alkenyl-oxy groups such as an isopropenyl-oxy group and an isobutenyl-oxy group; and the like. The branched compound has a molecular weight ranging preferably approximately from 1×10⁴ to 1×10⁶, and more preferably approximately from 1×10⁵ to 1×10⁶. Setting the molecular weight within the above range allows relatively easily setting the viscosity of the liquid material within the range described above.

Preferably, the branched compound as above has a silanol group. Specifically, in the structural units expressed by the above general formulas (1) to (3), each group indicated by Z is preferably a hydroxyl group. Accordingly, in the step 3 below, when the liquid coating film 30 is dried so as to obtain the bonding film 3, the hydroxyl groups included in the adjacent branched compounds are bonded each other. Therefore, the obtained bonding film 3 has superior film strength. Further, as described above, if the first substrate 21 having a hydroxyl group exposed on the bond surface (a main surface) 23 is used, the hydroxyl group of the branched compound and that of the first substrate 21 are bonded each other. Thus, the branched compound can be bonded to the first substrate 21 both physically and chemically. As a result, the bonding film 3 is strongly bonded to the bond surface 23 of the first substrate 21.

Preferably, the hydrocarbon group linked to the silicon atom of the silanol group is a phenyl group. That is, each group indicated by R in the structural units expressed by the above general formulas (1) to (3) including each group Z as a hydroxyl group is preferably a phenyl group. Accordingly, reactivity of the silanol group is further improved, and thereby further facilitating bonding between the adjacent hydroxyl groups in the branched compound.

Alternatively, the hydrocarbon group linked to the silicon atom of the silanol group that is not linked to the silicon atom is preferably a methyl group. That is, the group R included in the structural units expressed by the general formulas (1) to (3) excluding the group Z is preferably a methyl group. The compound including a methyl group as the group R included in the structural unit expressed by each of the general formulas (1) to (3) excluding the group Z is relatively easily available at low cost. Further, in a step 4 below, since energy for bonding is applied to the bonding film 3, the methyl group is easily cleaved, and whereby adhesiveness is surely developed on the bonding film 3. Therefore, the compound including a methyl group is preferably used as the branched compound (the silicone material). Considering from the hereinabove, for example, a compound expressed by a following formula (4) is preferably used as the branched compound.

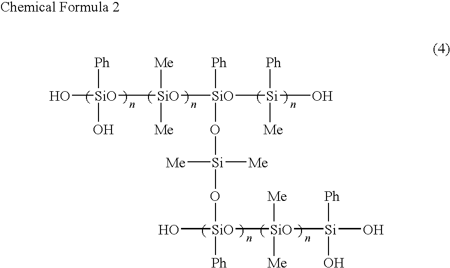

[In the above formula, each n independently represents an integer of 0 or 1 or more.]

In addition, the branched compound described above is a relatively flexible material. Thus, in a step 5 below, when obtaining the bonded body 1 by bonding the first substrate 21 and the second substrate 22 with the bonding film 3 interposed therebetween, stress due to thermal expansion between the substrates 21 and 22 can be surely reduced even if the first substrate 21 and the second substrate 22 are made of a different material, for example. Accordingly, prevention of undesired separation can be ensured in the bonded body 1 finally obtained.

In addition, the branched compound has high chemical resistance and thus can be effectively used to bond members together exposed to chemicals or the like for a long period of time. Specifically, for example, in production of a droplet discharge head for an industrial inkjet printer using an organic ink tends to erode a resin material, the members are bonded together with the bonding film 3 so that durability of the head is surely improved. Furthermore, since the branched compound has high heat resistance, it can be effectively used to bond the members together exposed to a high temperature.

Next, at the step 3, the liquid coating film 30 formed on the first substrate 21 is dried so as to form the bonding film 3 (refer to FIG. 1C). A temperature for drying the liquid film is preferably 25° C. or more, and more preferably approximately from 25° C. to 100° C. A time for drying the liquid coating film 30 is preferably approximately 0.5 hour to 48 hours, and more preferably approximately 15 hours to 30 hours.

Drying the liquid coating film 30 under the above condition, in the step 4 below, can ensure formation of the bonding film 3 of which adhesiveness is preferably developed by applying energy. If a material including a silanol group as described in the step 2 above is used as the silicone material, the silanol group included in the silicone material, further, the silanol group included in the silicone material and the hydroxyl group included in the first substrate 21, can be surely boned. As a result, the formed bonding film 3 has superior film strength, and can be strongly boned to the first substrate 21.

An ambient pressure in the drying process may be an atmospheric pressure, but preferably a reduced pressure. Specifically, a value of the reduced pressure is preferably from approximately 133.3×10⁻⁵ Pa to 1333 Pa (1×10⁻⁵ Torr to 10 Torr), and more preferably approximately 133.3 Pa×10⁻³ to 133.3 Pa (1×10⁻⁴ Torr to 1 Torr). Accordingly, layer density of the bonding film 3 is densified and thereby the bonding film 3 having superior film strength is obtained. As described above, by appropriately setting the conditions for forming the bonding film 3, the bonding film 3 having desired film strength can be obtained.

An average thickness of the bonding film 3 preferably ranges approximately from 10 nm to 10000 nm, and more preferably approximately from 50 nm to 5000 nm. Setting the average thickness of the formed bonding film 3 within the range by appropriately determining the amount of the supplied liquid material can prevent a significant decrease in dimensional accuracy of the bonded body 1 obtained by bonding the first substrate 21 and the second substrate 22. Further, by appropriately setting conditions of applying energy described later, the bonding strength of the bonding film 3 can be more easily controlled. If the average thickness of the bonding film 3 is below the lower limit, the bonding strength of the finally obtained bonded body 1 may not be sufficient. Meanwhile, if the average thickness of the bonding body 3 is larger than the upper limit, the dimensional accuracy of the bonded body 1 may be significantly decreased.

Further, setting the average thickness of the bonding film 3 within the range allows the film 3 to be elastic to some extent. Accordingly, in the step 5 below, when bonding the two substrates 21 and 22 together, even if any particle and the like are adhered on the bond surface 24 of the second substrate 22 to be contacted with the bonding film 3, the bonding film 3 is bonded to the bond surface 24 in a manner such that the particle and the like are surrounded by the bonding film 3. This can appropriately suppress or prevent decrease in the bonding strength on an interface between the bonding film 3 and the bond surface 24 and separation occurring on the interface due to the presence of the particle and the like. In the invention, the bonding film 3 is formed by supplying the liquid material. Accordingly, even if an uneven spot exists on the bond surface 23 of the first substrate 21, the bonding film 3 can be formed in accordance with a shape of the uneven spot depending on a height of the uneven spot. As a result, the bonding film 3 covers the uneven spot, thus enabling a surface of the film to be almost flattened.

Next, at the step 4, energy is applied to a main surface 32 of the bond surface 23. In the present embodiment, the energy is selectively applied by irradiating the main surface 32 of the bonding film 3 positioned at a first region 33 with the energy rays (refer to FIG. 1D.) That is, selectively applying the energy to the first region 33 allows changing an amount of energy applied to each region of the bonding film 3. Appropriately setting the conditions for applying energy to the bonding film 3 adjusts an activated state of the main surface 32 of the bonding film 3. Therefore, bonding strength of the bonding film 3 is adjusted. As a result, bonding strength of the finally obtained bonded body 1 can be adjusted. The bonding strength of the bonded body 1 is appropriately determined in accordance with a purpose of use and a region to be used.

In a region of the bonding film 3 to which the energy rays are irradiated, a part of the molecular bond around the main surface 32 is cleaved. Then, due to the activation of the main surface 32, adhesiveness with respect to the second substrate 22 is developed around the main surface 32. The first substrate 21 in such a state can be chemically bonded to the second substrate 22.

Here, in this specification, a state that the main surface 32 is “activated” is referred to as a state in which a part of the molecular bond of the main surface 32 of the bonding film 3, specifically, for example, the methyl group included in a polydimethylsiloxane skeleton is cleaved, and an unterminated bond (hereinafter, also referred to as the “free bond” or the “dangling bond”) occurs on the bonding film 3, as described as above. Also, a state in which the free bond is terminated by the hydroxyl group (an OH group), and further includes a state in which these states are mixed together. In a further activated state that includes more free bonds, the bonding strength of the bonding film 3 is increased. In contrast, in a less activated state that includes a few free bonds, the bonding strength of the bonding film 3 is decreased.

Any method may be used for applying energy on the bonding film 3. Examples of the method includes irradiating the bonding film 3 with the energy rays, heating the bonding film 3, applying a pressure (physical energy) on the bonding film 3, exposing the bonding film 3 to plasma (applying plasma energy), exposing the bonding film 3 to ozone gas (applying chemical energy), and the like. Accordingly, the surface of the bonding film 3 is efficiently activated, so that adhesiveness of the bonding film 3 is easily adjusted. In addition, since a molecular structure of the bonding film 3 is not cleaved more than necessary, degrading a characteristic of the bonding film 3 is avoided.

Among the methods above, in the present embodiment, irradiating the bonding film 3 with the energy rays is used as the method for applying energy on the bonding film 3. The method enables an amount of energy applied to be easily adjusted with accuracy. Therefore, an amount of the molecular bond to be cleaved on the bonding film 3 can be adjusted. Adjusting the amount of the molecular bond to be cleaved allows easily adjusting adhesiveness of the bonding film 3, whereby easily controlling the bonding strength between the first substrate 21 and the second substrate 22.

That is, increasing the amount of the molecular bond to be cleaved around the main surface 32 allows the main surface 32 of the bonding film 3 to have more activation hand (the dangling bond), whereby the adhesiveness developed on the bonding film 3 is increased. Meanwhile, decreasing the amount of the molecular bond to be cleaved around the main surface 32 allows the main surface 32 of the bonding film 3 to have less activation hand, whereby the adhesiveness developed on the bonding film 3 is decreased.

When the energy is applied on the bonding film 3 by irradiating the energy rays, adjusting conditions enables the amount of the energy applied on the bonding film 3 to be easily adjusted. The conditions include kinds of energy rays, an output of the energy rays, irradiation time of the energy rays, and the like. According to the method for irradiating energy rays, a large amount of energy can be applied in a short time, so that the energy can be efficiently applied. Further, according to the method for irradiating energy rays, the energy can be easily selectively applied with respect to the bonding film 3.

Examples of the energy rays include lights such as ultraviolet rays and laser lights; electromagnetic rays such as X-rays and gamma rays; particle beams such as electron beams and ion beams; and a combination of two kinds or more of these energy rays. Among them, energy rays having high directivity such as the laser lights and the electron beams are especially preferably used. With the energy rays, irradiating an objective direction with the energy rays allows a predetermined region to be selectively and easily irradiated.

In addition, ultraviolet rays having a wavelength approximately from 126 nm to 300 nm are preferably used. The ultraviolet rays within the range allow the amount of energy applied to be optimized. Therefore, the molecular bond serving as a skeleton of the bonding film 3 can be prevented from being destroyed more than necessary, and the molecular bond existing from the bonding film 3 to around the main surface 32 can be selectively cleaved. Accordingly, a characteristic (a mechanical characteristic, a chemical characteristic, and the like) of the bonding film 3 can be prevented from being degraded, and adhesiveness of the bonding film 3 can be surely developed, thereby allowing the bonding strength of the bonding film 3 to be more easily adjusted.

In addition, the wavelength of the ultraviolet rays is more preferably approximately from 126 nm to 300 nm. With the ultraviolet rays, the energy can be evenly applied on a wide area in a short time, whereby the molecular bond can be efficiently cleaved. Furthermore, for example, the ultraviolet rays can be generated with simple equipment such as an UV lamp. When the ultraviolet rays are irradiated by using the UV lamp, an output of the UV lamp differs corresponding to an area of the bonding film 3. However, the output is preferably approximately from 1 mW/cm² to 1 W/cm², and more preferably from 5 mW/cm² to 50 mW/cm². In this case, a separation distance between the UV lamp and the bonding film 3 is preferably approximately from 3 mm to 3000 mm, and more preferably approximately from 10 mm to 1000 mm.

The ultraviolet rays are preferably irradiated for a period of time in which the molecular bond around the main surface 32 of the bonding film 3 can be cleaved, that is, a period of time in which the molecular bond existing around the surface of the bonding film 3 can be selectively cleaved. Specifically, even though it is slightly different in accordance with a light amount of the ultraviolet rays and a material composing the bonding film 3, the ultraviolet rays are preferably irradiated for approximately from 1 second to 30 minuets, and more preferably approximately from 1 second to 10 minutes. Additionally, the ultraviolet rays may be irradiated temporally continuously or irradiated intermittently (in a pulse).

Meanwhile, examples of the laser lights include pulsed oscillation lasers (pulse lasers) such an eximer lasers, and continuous oscillation lasers such as carbon dioxide lasers and semiconductor lasers. Among them, the pulse laser is preferably used. With the pulse laser, since a part of the bonding film 3 where the laser light is irradiated hardly accumulates heat as time passes, the bonding film 3 can be surely prevented from being altered and deteriorated by the accumulated heat. That is, using the pulse laser, an internal part of the bonding film 3 can be prevented from being affected by the accumulated heat.

A pulse width is preferably as short as possible when the affection of the heat is taken into consideration. Specifically, the pulse width is preferably 1 ps (pico second) or less, and more preferably 500 fs (femto second) or less. Setting the pulse width within the range allows the affection of the heat occurring on the bonding film 3 with the irradiation of the laser light to be surely suppressed. Additionally, a pulse laser having a small pulse width around the range above is called a “femtosecond laser.”

Further, a wavelength of the laser light is not particularly limited. However, it is preferably approximately from 200 nm to 1200 nm, and more preferably approximately from 400 nm to 1000 nm, for example. A peak power of the laser light differs according to the pulse width for a pulse laser. However, it is preferably approximately from 0.1 W to 10 W, and more preferably approximately from 1 W to 5 W. Further, a repetition frequency of the pulse laser is preferably approximately from 0.1 kHz to 100 kHz, and more preferably approximately from 1 kHz to 10 kHz. Setting the frequency of the pulse laser within the range allows the molecular bond around the main surface 32 to be selectively cleaved.

In addition, various conditions for the laser light are appropriately adjusted such that a temperature of a part irradiated by the laser light is preferably approximately from room temperature (ambient temperature) to 600° C., more preferably approximately from 200° C. to 600° C., and further preferably approximately from 300° C. to 400° C. Accordingly, the temperature of the part irradiated by the laser light can be prevented from being remarkably raised, and the molecular bond around the main surface 32 can be selectively cleaved. The laser light irradiating the bonding film 3 is preferably scanned along the main surface 32 in a state such that a focal point of the laser light is adjusted to the main surface 32 of the bonding film 3. Thus, heat generated by the irradiation of the laser light is locally accumulated around the main surface 32. As a result, the molecular bond existing on the main surface 32 of the bonding film 3 can be selectively separated.

The irradiation of the energy rays to the bonding film 3 may be performed in any atmosphere. Examples of the atmosphere include oxidizing gas atmospheres such as an ambient atmosphere and an oxygen atmosphere; reducing gas atmospheres such as a hydrogen atmosphere; inert gas atmospheres such as a nitrogen atmosphere and an argon atmosphere; reduced pressure (vacuum) atmospheres reducing a pressure in those atmospheres, and the like. Among them, the irradiation of the energy rays is preferably performed in the ambient atmosphere (especially, under an atmosphere having a low dew point). Thus, ozone gas is generated around the main surface 32, and the activation thereof is performed more smoothly, whereby easily adjusting the bonding strength of the bonding film 3. Further, without any trouble and cost for controlling the atmosphere, the irradiation of the energy rays can be more easily performed.

According to the method for irradiating energy rays, since the energy is easily selectively applied to the bonding film 3, the first substrate 21 can be prevented from being altered and deteriorated by the application of the energy, for example. In addition, if the energy is applied to the bonding film 3 by a method other than irradiating energy rays, adjusting the amount of energy applied to the bonding film 3 allows the bonding strength of the bonding film 3 to be easily adjusted.

As described above, in the present embodiment, conditions for applying energy for each region of the bonding film 3 is changed as a method for adjusting adhesiveness of the bonding film 3. Specifically, as shown in FIG. 1D, a mask 6 having windows 61 that forms a shape corresponding to a shape of a region to be irradiated by the energy rays (for example, the first region 33) is provided above the main surface 32 of the bonding film 3. Then, the energy rays are irradiated with the mask 6 therebetween. Thus, the energy rays are easily selectively irradiated to the region (the first region 33) to be irradiated by the energy rays. Accordingly, adhesiveness is developed on the bonding film 3 positioned at the first region 33 while adhesiveness is not developed on the bonding film 3 positioned at a second region 34.

That is, the energy is applied to the bonding film 3 positioned at the first region 33 and positioned at the second region 34, a region different from the first region 33, under a different condition, whereby the amount of energy applied to the bonding film 3 is adjusted. Consequently, the bonding film 3 positioned at the first region 33 and the second region 34 have different adhesiveness, and the adhesiveness of the bonding film 3 as a whole can be easily adjusted.

In such a case, the adhesiveness as the whole bonding film 3 is adjusted, for example, by changing an area ratio of the bonding film 3 of the first region 33 and the bonding film 3 of the second region 34 when the bonding film 3 is viewed from the above. More specifically, increasing the area ratio of the bonding film 3 of the first region 33 allows the whole bonding film 3 to have high adhesiveness. Meanwhile, decreasing the area ratio of the bonding film 3 of the first region 33 makes the whole bonding film 3 to have low adhesiveness.

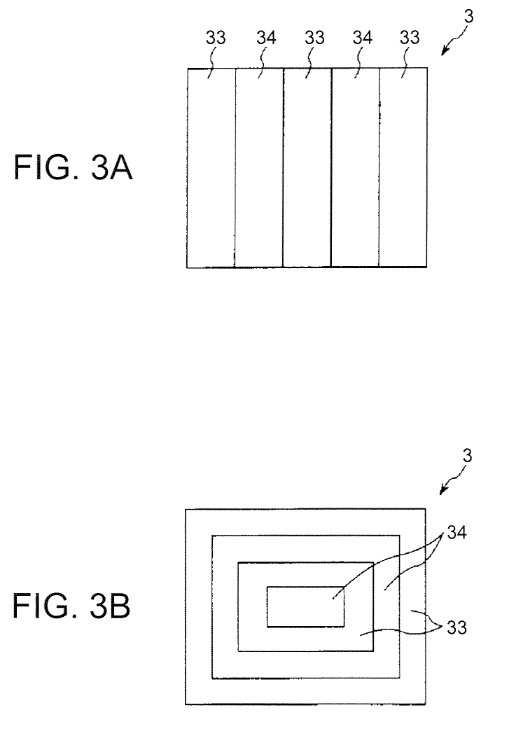

Any pattern may be used for the first region 33 and the second region 34 when the bonding film 3 is viewed from the above, and may be appropriately set in accordance with a shape and a characteristic of the second substrate 22 to be bonded. Examples of the pattern includes a pattern in which the first region 33 and the second region 34 formed in a strip are alternately provided as shown in FIG. 3A, and a pattern in which the second region 34 formed in a square is alternately surrounded by the first region 33 and the second region 34 formed in a square.

Further, when the bonding film 3 is viewed from the above, a region having high adhesiveness (the first region 33 in the present embodiment) is preferably provided at an edge of the bonding film 3 as shown in FIGS. 3A and 3B. Accordingly, in the obtained bonded body 1, undesired separation hardly occurs between the first substrate 21 and the second substrate 22. As a result, certain bonding strength can be kept for a long period of time. Additionally, if energy rays having high directivity are used, the energy rays can be selectively irradiated to a region (the first region 33) to be irradiated without using the mask.

Next, at the step 5, the first substrate 21 and the second substrate 22 are bonded each other such that the bonded film 3 and the second substrate 22 are adhered closely to each other (refer to FIG. 2E). Since adhesiveness with respect to the second substrate 22 is developed on the main surface 32 of the bonding film 3 positioned at the first region 33 in the step 4 above, the bonding film 3 positioned at the first region 33 and the bonding film 24 of the second substrate 22 are chemically bonded. As a result, the first substrate 21 and the second substrate 22 are bonded to each other with a part of the bonding film 3 where the energy is applied interposed therebetween, whereby obtaining the bonded body 1 as shown in FIG. 2F.

In the thus obtained bonded body 1, unlike an adhesive used in conventional bonding methods in which a bond is based on mainly a physical bond supported by an anchor effect, the two substrates 21 and 22 are bonded each other based on a chemical bond such as a covalent bond occurring in a short period of time. Accordingly, the bonded body 1 can be formed in a short period of time, and undesired bonding unevenness hardly occurs.

According to the bonding method, a thermal processing at high temperature (for example, 700° C. or higher) is unnecessary, so that the first substrate 21 and the second substrate 22 both made of a material with low thermal resistance can be bonded together. Since the first substrate 21 and the second substrate 22 are bonded each other with the bonding film 3 interposed therebetween, a constituent material of each of the substrates 21 and 22 are not limited. As described above, according to the invention, each constituent material of the first substrate 21 and the second substrate 22 has a wide range of choices.

Further, in the bonding method of the invention, since adhesiveness of the bonding film 3 can be adjusted, for example, if the same component (the first substrate 21) including the bonding film 3 is used for a plurality kinds of products, each product can have different adhesiveness when the component is used. That is, the bonding method of the invention is advantageous for manufacturing products of diversified small-quantity production. In addition, if the first substrate 21 and the second substrate and 22 have a different coefficient of thermal expansion from each other, they are preferably bonded under low temperature as possible. Bonding under low temperature allows thermal stress occurring at a bonded interface to be further reduced.

Specifically, though it depends on a difference of coefficient of thermal expansion between the first substrate 21 and the second substrate 22, the first substrate 21 and the second substrates 22 are preferably bonded under a state in which a temperature of the first substrate 21 and the second substrate 22 is approximately from 25° C. to 50° C., and more preferably approximately 25° C. to 40° C. With this temperature range, even if a difference of thermal expansion between the first substrate 21 and the second substrate 22 is relatively large, thermal stress occurring at a bonded interface is substantially reduced. As a result, the bonded body 1 is surely prevented from being warped or separated.

In this case, if a difference of thermal expansion between the first substrate 21 and the second substrate 22 is specifically 5×10⁻⁵/K or more, the substrates are especially recommended to be bonded under low temperature as possible as above. In the present embodiment, as shown in the step 4 above and the present step 5, the bonded body 1 is obtained by bringing the first substrate 21 and the second substrate 22 into contact with each other with the bonding film 3 interposed therebetween after applying the energy to the bonding film 3 so as to develop adhesiveness around the bond surface (the main surface) 32 of the bonding film 3. However, it is not particularly limited to this. The bonded body 1 may be obtained by applying the energy to the bonding film 3 after bringing the first substrate 21 and the second substrate 22 into contact with each other with the bonding film 3 interposed therebetween. In other words, an order of the previous step 4 and the present step 5 may be reversed so as to obtain the bonded body 1. In a case such that each step is performed in this order to obtain the bonded body 1, the same effects described above is also obtained.

Here, a mechanism for bonding the first substrate 21 and the second substrate 22 in the present step will be described. As an example, the hydroxyl group exposed on the bond surface 24 of the second substrate 22 will be explained. In the step, when the bonding film 3 formed on the first substrate 21 and the bond surface 24 of the second substrate 22 are bonded together so as to bring them in to contact with each other, the hydroxyl group existing on the main surface 32 of the bonding film 3 and the hydroxyl group existing on the bond surface 24 of the second substrate 22 attract each other by a hydrogen bond. Accordingly, an attraction force is generated between the hydroxyl groups. It is assumed that the first substrate 21 and the second substrate 22 are bonded together by this attraction force.

The hydroxyl groups attract each other by the hydrogen bond are cleaved from the surface with dehydration condensation by a temperature condition and the like. As a result, at a contact interface between the first substrate 21 and the second substrate 22, the bonds including the hydroxyl group are bonded each other. Thus, it is assumed that the first substrate 21 and the second substrate 22 are more strongly bonded. If the unterminated bonds or the free bonds (the dangling bonds), exist at the surface or the internal part of the bonding film 3 of the first substrate 21 and the bond surface 24 or an internal part of the second substrate 22, these free bonds are rebonded when the first substrate 21 and the second substrate 22 are bonded each other. Since the free bonds are complexly rebonded such that the free bonds are overlapped (intertangled) each other, a bond of a network-like is formed on the bonded interface. Accordingly, the bonding film 3 and the second substrate 22 are especially strongly bonded.

Further, the surface of the bonding film 3 activated in the step 4 above, the activated state is temporally reduced. Thus, the present step 5 is preferably performed as fast as possible after the previous step 4. Specifically, the step 5 is preferably performed within 60 minuets after the step 4, and more preferably within 5 minuets. Within the time, since the surface of the bonding film 3 keeps the sufficient activated state, when the first substrate 21 and the second substrate 22 are bonded together, desired bonding strength can be obtained to a space therebetween.

In other words, the bonding film 3 before the activation is obtained by drying a silicone material, thereby it is relatively chemically stable and has high weatherability. Therefore, the bonding film 3 before the activation is suitable for a long-term storage. Accordingly, a large amount of the first substrate 21 having such the bonding film 3 may be manufactured or purchased and stored. Then, before the bonding process of the present step, energy is only applied to a required number of the first substrate 21 as described in the step 4 above. This is beneficial from viewpoint of manufacturing efficiency of the bonded body 1.

As described above, the bonded body (the bonded body of the invention) 1 shown in FIG. 2F can be obtained. In addition, in the process of obtaining the bonded body 1 or after obtaining the bonded body 1, at least one step (a step for increasing bonding strength of the bonded body 1) out of three steps below (steps 6A, 6B, and 6C) may be performed with respect to the bonded body 1 if necessary. Accordingly, the bonding strength of the bonded body 1 can be easily improved.

At the step 6A, as shown in FIG. 2G, the obtained bonded body 1 is pressurized so that the first substrate 21 and the second substrate 22 come close to each other. Therefore, the surface of the bonding film 3 comes closer to each surface of the first substrate 21 and the second substrate 22, whereby the bonding strength of the bonded body 1 can be further increased. Additionally, pressurizing the bonded body 1 allows gaps remain on the bonded interface of the bonded body 1 to be crushed, whereby a junction area can be further enlarged. Thus, the bonding strength of the bonded body 1 can be further improved.

The pressure is appropriately adjusted in accordance with a material and a thickness of each of the first substrate 21 and the second substrate 22, conditions of a bonding device, and the like. Specifically, even though it is slightly different depending on the material and the thickness of the first substrate 21 and the second substrate 22, the pressure is preferably approximately from 0.2 MPa to 10 MPa, and more preferably approximately 1 MPa to 5 MPa. Thus, the bonding strength of the bonded body 1 is surely increased. The pressure may exceed the upper limit value. In this case, the first substrate 21 and the second substrate 22 may be damaged or the like depending on the material of the substrates. A time to pressurize is not particularly limited, and it is preferably approximately from 10 seconds to 30 minutes. In addition, the time to pressurize may be appropriately changed depending on a pressure to be applied. Specifically, as the pressure applied on the bonded body 1 is higher, the bonding strength of the bonded body 1 is improved even if the time to pressurize is shorter.

At the step 6B, the bonded body 1 is heated as shown in FIG. 2G. Thus, the bonding strength of the bonded body 1 is further improved. At this time, a heating temperature for the bonded body 1 is not specifically limited as long as the temperature is higher than room temperature and lower than an upper temperature limit of the bonded body 1. The heating temperature is preferably approximately from 50° C. to 200° C., and more preferably approximately from 50° C. to 150° C. Heating within the range can surely prevent the bonded body 1 from being altered and deteriorated due to heat and also can surely ensure the bonding strength.

A heating time is not particularly limited, but it is preferably approximately from 1 minute to 30 minutes. Additionally, if the steps 6A and 6B are both performed, these steps are preferably performed at one time. That is, as shown in FIG. 2G, the bonded body 1 is preferably heated while being pressurized. Thus, an effect of pressurizing and an effect of heating are synergistically exerted, thereby the bonding strength of the bonded body 1 is especially improved.

At the step 6C, the obtained bonded body 1 is irradiated with the energy rays. Thus, a chemical bond formed between the bonding film 3 and the second substrate 22 is increased, thereby the bonding strength of the bonded body 1 is especially enhanced. At this time, conditions for irradiating energy rays may be the same as that of the energy rays shown in the step 4 above. In a case where the present step 6C is performed, one of the first substrate 21 and the second substrate 22 is required to have translucency. Then, the energy rays are irradiated from a side of the substrate having translucency so that the energy rays are surely irradiated with respect to the bonding film 3.

At this time, with respect to the bonding film 3 positioned at the first region 33 and the second region 34, the conditions for irradiating energy rays may be different. In addition, with respect to the bonding film 3 positioned at the first region 33 or the second region 34, the energy rays may be selectively irradiated. Accordingly, the bonding strength of the bonded body 1 is easily improved. The energy is applied to the bonding film 3 multiple times, so that the amount of energy applied to the bonding film 3 is adjusted with higher accuracy. Furthermore, with respect to each region of the bonding film 3, the energy is more easily applied under different conditions.

Combining the step 4 and at least one step out of 6A, 6B, and 6C allows each region of the bonding film 3 to easily have a different amount and condition of energy applied. That is, at least one of the steps out of 6A, 6B, and 6C is performed so as to apply the energy to a region positioned at the first region 33 and the second region 34 of the bonding film 3. Therefore, the bonding strength of the bonding film 3 positioned at the first region 33 and the second region 34 is improved. Accordingly, since the bonding film 3 positioned at the first region 33 and the second region 34 have a different amount and condition of energy applied, the bonded body 1 having different bonding strength is easily obtained.

Additionally, for example, in the step 4 above, the bonding strength of the bonded body 1 may be adjusted to a desired one as follows. Relatively weak adhesiveness is developed as less amount of energy applied to the bonding film 3, and the bonded body 1 having relatively weak adhesiveness is obtained after the bond. Then, at least one step out of the three steps above (6A, 6B, and 6C) is performed so as to obtain the desired bonding strength. Accordingly, the bonded body 1 shortly after the bond is easily separated when displacement and the like occur. The steps 4 and 5 above are performed again, so that the first substrate 21 and the second substrate 22 are rebonded. Therefore, at least one step out of the three steps above (6A, 6B, and 6C) can be performed in a state such that displacement is prevented, thereby the finally obtained bonded body 1 has high dimensional accuracy and desired bonding strength.

In the bonded body 1 obtained by the bonding method described above, adhesiveness of the bonding film 3 is adjusted when the first substrate 21 and the second substrate 22 are bonded each other. Thus, the bonding strength of the bonded body 1 is easily adjusted. As a result, for example, the bonding strength of the first substrate 21 and the second substrate 22 may be large, and it also may be small. Accordingly, the first substrate 21 and the second substrate 22 may be strongly bonded each other, and it also may be easily separated from each other.

That is, the bonding strength of the bonded body 1 can be adjusted, and strength for separating the bonded body (cleavage strength) can be adjusted at the same time. In this regard, when manufacturing the bonded body 1 that can be easily separated, the bonding strength of the bonded body 1 is preferably manually separable. Accordingly, the bonded body 1 is separated easily without using a device and the like. In this case, the first substrate 21 and the second substrate 22 can be easily recycled.

Having different adhesiveness for each region of the bonding film 3 allows preventing the bonded body 1 from undesired separation. For example, a region to which an external force is easily applied, the bonding strength of the bonding film 3 corresponding to the region can be increased. On the other hand, for example, if the first substrate 21 and the second substrate 22 include a region easily destroyed by stress, the bonding strength of the bonding film 3 corresponding to the region is decreased so as to prevent the stress on the region.

In addition, adhesiveness of the bonding film 3 can be appropriately adjusted according to a usage of the bonded body 1. For example, if the bonded body 1 is used such that only an area positioned at a part of a region of the first substrate 21 is separated, the adhesiveness of the bonding film 3 corresponding to the area only positioned at the part of the region may be decreased while the adhesiveness of the bonding film 3 corresponding to another part of the first substrate 21 may be increased to prevent another part from being separated.

Further, for example, adhesiveness of each region of the bonding film 3 may be continuously varied. Appropriately setting an area and a shape of the bonding film 3 where the first substrate 21 and the second substrate 22 are bonded together enables local concentration of stress occurring on the bonding film 3 to be reduced. Accordingly, even if a difference of coefficient of thermal expansion between the first substrate 21 and the second substrate 22 is large, each of the substrates 21 and 22 can be surely bonded.

### Second Embodiment

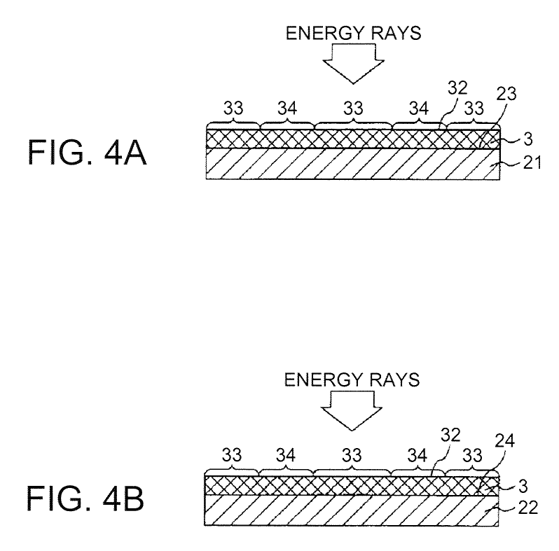

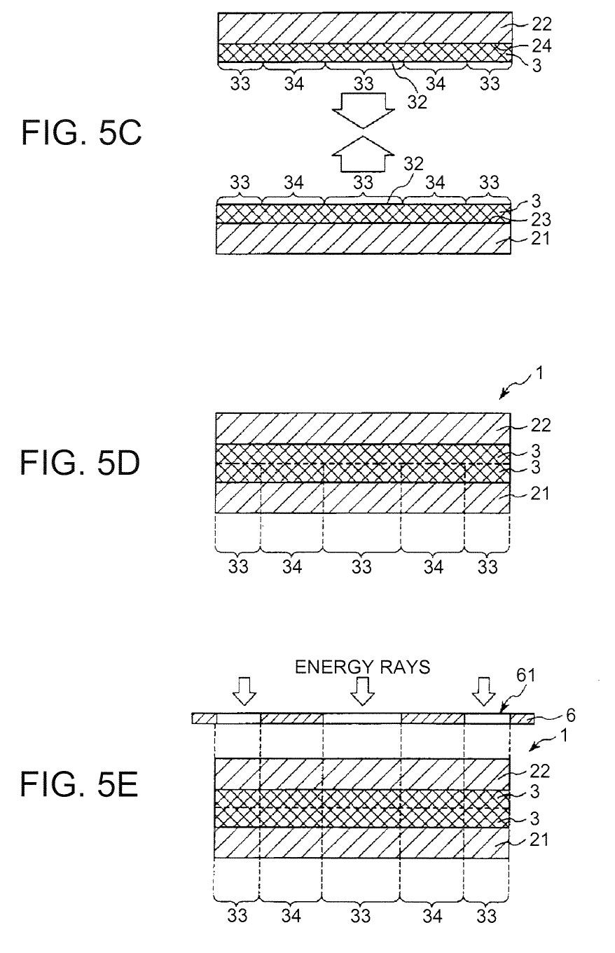

Next, a second embodiment of the bonding method according to the invention will be described. FIGS. 4A, 4B, 5C, 5D, and 5E are diagrams (vertical sectional diagrams) for explaining the second embodiment exemplifying the bonding method of the invention. Note that the top side of FIGS. 4A to 5E is referred to as “up” and the bottom side thereof is referred to as “down” in the following descriptions. The second embodiment of the bonding method will be described below. In the description, differences from the first embodiment of the bonding method will be mainly explained, and the same contents are omitted.

In the bonding method according to the present embodiment, the bonding film 3 is not only formed on the bond surface (the main surface) 23, but also formed on the bond surface (the main surface) 24 of the second structure 22 as well. Then, energy is applied to areas positioned at the first and the second regions 33 and 34 of the bonding film 3 included in the respective substrates 21 and 22 so as to develop adhesiveness around the main surface 32 of the bonding film 3 included in the respective substrate 21 and 22. The adhesiveness is given to the areas positioned at the first and the second regions 33 and 34 of the bonding film 3. Then, the bonding film 3 included in the respective substrates 21 and 22 is brought into contact with each other so as to bond the two substrates 21 and 22 together. As a result, the bonded body 1 is obtained. Further, other than the adhesiveness of the bonding film 3 positioned at the first region 33 is increased by selectively applying energy to the region positioned at the first region 33 of the bonding film 3, the bonding method is the same as that described in the first embodiment. That is, the bonding method of the present embodiment is such that the bonding film 3 is respectively formed on both the first substrate 21 and the second substrate 22 so as to bond the first substrate 21 and the second substrate 22 by integrating the bonding film 3.

At a step 1′, first, the first substrate 21 and the second substrate 22 similar to those in the step 1 above are prepared. At a step 2′, next, in the same manner as described in the steps 2 and 3 above, the bonding film 3 is respectively formed on both the bond surface 23 of the first substrate 21 and the bond surface 24 of the second substrate 22. At a step 3′, next, as shown in FIGS. 4A and 4B, in the same manner as described in the step 4 above, energy is applied to the bonding films 3 respectively formed on both the first substrate 21 and the second substrate 22 so as to develop adhesiveness around the main surface 32 of each of the bonding film 3. At this time; the energy is applied to the regions positioned at the first region 33 and the second region 34 of the main surface 32 of each bonding film 3.

Any method for applying energy may be employed. Examples of the method, in the same manner as described in the first embodiment, includes irradiating energy rays on the bonding film 3, heating the bonding film 3, applying a pressure (physical energy) on the bonding film 3, exposing the bonding film 3 to plasma (applying plasma energy), exposing the bonding film 3 to ozone gas (applying chemical energy), and the like. The method may be used singly or in a combination of two or more of them.

As a step 4′, next, as shown in FIG. 5C, the bonding film 3 having developed adhesiveness thereon included in the respective substrates 21 and 22 are bonded together so that the respective substrates are adhered closely to each other. As a result, the substrates 21 and 22 are bonded each other with the respective bonding films 3, whereby obtaining the bonded body 1 as shown in FIG. 5D. At a step 5′, as shown in FIG. 5E, at least one step out of 6A, 6B, and 6C of the first embodiment above is performed so as to selectively apply energy to a region positioned at the first region 33 of the bonding film 3.

In this step, energy rays are preferably irradiated as a method for applying energy. Accordingly, the energy is easily applied to the first region 33 with high accuracy. The bonding method according to each embodiment above may be used to bond various kinds of a plurality of members.

The members employed for the bond is not particularly limited. Examples of the members include semiconductor elements such as transistors, diodes, and memories; piezoelectric elements such as quartz oscillators; optical elements such as reflective mirrors, optical lenses, diffraction gratings, and optical filters; photoelectric converting elements such as solar cells; components for micro electro mechanical systems (MEMS) such as semiconductor substrates with semiconductor elements mounted thereon, insulating substrates with wirings or electrodes, inkjet recording heads, micro reactors, and micro mirrors; sensor components such as pressure sensors and acceleration sensors; packaging components of semiconductor elements and electronic components; storage media such as magnetic storage media, optical magnetic storage media, and optical storage media, display element components such as liquid crystal display elements, organic EL elements, and electrophoretic display elements; primary battery components; secondary battery components such as lithium ion secondary battery components; and fuel cell components.

Lithium Ion Secondary Battery

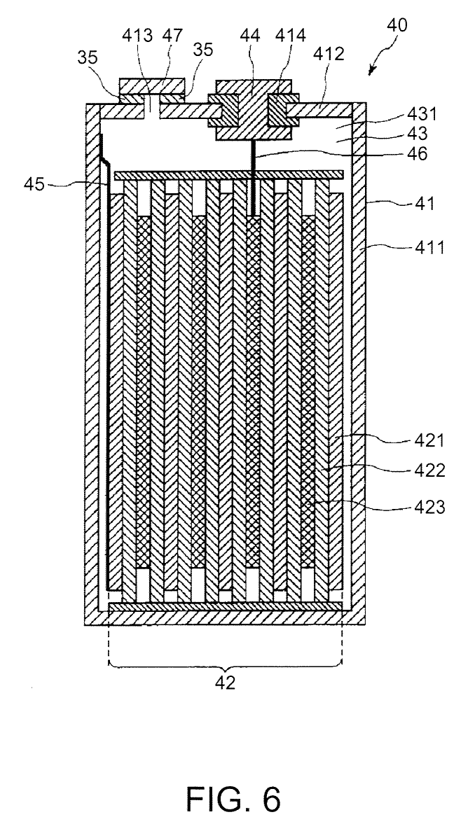

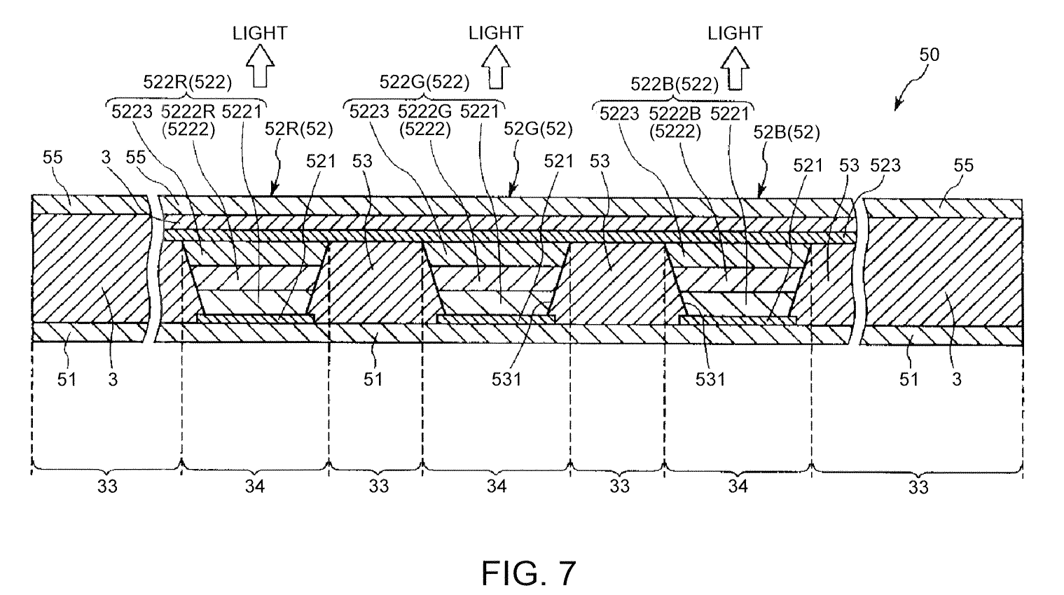

Next, a lithium ion secondary battery to which the bonding method described above is applied will be described. FIG. 6 is a sectional view of the lithium ion secondary battery manufactured by using the bonding method of the invention. Note that the top side in FIG. 6 is referred to as “up” while the bottom side thereof is described as “down” in the following descriptions. As shown in FIG. 6, a lithium ion secondary battery 40 includes a battery case 41, an electrode coil 42, an electrolytic solution 43, a positive terminal 44, and a safety valve 47.

The battery case 41 includes a case body 411 and a sealing part 412. The case body 411 is formed in a bottomed cylinder shape having a rectangle shaped bottom, and includes an opening provided on its top. The sealing part 412 seals the opening of the case body 411, and is formed in a plate shape corresponding to a shape of the opening. The battery case 41 has a function maintaining the electrode coil 42, the electrolytic solution 43, and the like. The battery case 41 is coupled to the electrode coil 42 through a negative lead 45, and also functions as a negative terminal.

The sealing part 412 includes two openings. At one of the openings, a positive terminal 44 is provided so as to penetrate the sealing part 412. On the other hand, another one of the openings, an opening 413, is sealed with the safety valve 47. The battery case 41 is made of a material that hardly reacts with the electrolytic solution 43 and has conductive properties. For example, metal materials such as iron, aluminum, and the like may be used singly or in a combination of two or more of them.

The electrode coil 42 is sealed in the battery case 41 and includes a cathode 421, a separator 422, and an anode 423. The cathode 421, the separator 422, and the anode 423 respectively have a plate shape. Then, the cathode 421, the separator 422, the anode 423 are laminated in this order and winded so as to form the electrode coil 42. The cathode 421 is coupled to the battery case 41 through the negative lead 45.

The cathode 421 is made of, for example, a carbon material such as graphite and hard carbon. The anode 423 is made of, for example, a lithium transition metal oxide such as lithium cobaltate. The separator 422 is provided between the cathode 421 and the anode 423. The separator 422 has a function of passing lithium ions between the cathode 421 and the anode 423 while preventing a short circuit therebetween. The separator 422 is made of a porous insulator including holes that the lithium ions can move therethrough.

The separator 422 is made of any material as long as it has insulation properties. Examples of such a material include a resin material such as polyethylene and polypropylene. The electrolytic solution 43 fills a space 431 in the battery case 41. The electrolytic solution 43 includes a lithium salt (electrolyte) and a solvent dissolving the lithium salt.

As the lithium salt, for example, LiPF₆, LiBF₄, LiN(SO₂CF₃)₂, LiC(SO₂CF₃)₃, LiN(SO₂C₂F₅)₂, LiC(SO₂C₂F₅)₃, and the like may be used singly or in a combination of two or more of them. As the solvent, for example, cyclic carbonic acid esters such as ethylene carbonate and propylene carbonate; and chain carbonic acid esters such as dimethyl carbonate, diethyl carbonate, and ethyl methyl carbonate may be used singly or in a combination of two or more of them.

The positive terminal 44 is provided so as to penetrate the sealing part 412. The positive terminal 44 is coupled to the anode 423 through the positive lead 46. A material composing the positive terminal 44 is not particularly limited, and the same material used for the battery case 41 described above can be used, for example. In addition, an insulating film 414 is provided between the positive terminal 44 and the sealing part 412 so as to prevent a short circuit therebetween.

The safety valve 47 is provided on an outer surface of an upper part of the battery case 41 so as to seal the opening 413 of the sealing part 412. The safety valve 47 is bonded to the sealing part 412 with a bonding film 35 including a silicone material interposed therebetween by using the bonding method of the invention. The lithium ion secondary battery 40 having such a structure includes a bonded body composed of the safety valve (a first substrate) 47, the bonding film 35, and the sealing part (a second substrate) 412. The safety valve 47 is separated from the sealing part 412 if a pressure inside the battery case 41 is increased to a certain pressure or more. Then, the contents of the battery case 41 are released, so that the pressure inside the battery case 41 can be released. Since the bonded body is manufactured by using the bonding method of the invention, bonding strength of the bonded body including the safety valve 47 and the sealing part 412 can be adjusted. Therefore, appropriately adjusting the bonding strength between the safety valve 47 and the sealing part 412 allows the maximum pressure occurring inside the battery case 41 to be controlled.

The positive terminal 44 and the battery case (the negative terminal) 41 of the lithium ion secondary battery 40 are coupled to external power supply or electronic apparatus, whereby the battery is charged or discharged. An anode of the external power supply and the positive terminal 44 are coupled and a cathode of the external power supply and the battery case (the negative terminal) 41 are coupled to charge. The charge is performed by supplying power from the external power supply to the lithium ion secondary battery 40 so that the lithium ions existing in the anode 423 move to the cathode 421 through the holes of the separator 422.

The discharge is performed in a state that the outer apparatus is coupled to both the positive terminal 44 and the battery case (the negative terminal) 41. The discharge of the lithium ion secondary battery 40 is performed by moving the lithium ions once moved to the cathode 421 to the anode 423 through the holes of the separator 422. Then, power is supplied to the outer apparatus. If the lithium ion secondary battery is excessively charged or discharged, generally, undesired precipitation of metal ions and elution of the metal material into the electrolytic solution occur. In this case, the lithium ion secondary battery may produce heat by a short circuit and the like between the anode and the cathode. In addition, gas is generated by decomposition and volatilization of the electrolytic solution, so that the lithium ion secondary battery may be expanded. In the case above, the lithium ion secondary battery may explode.

However, since the lithium ion secondary battery 40 includes the safety valve 47, if a pressure inside the battery case 41 of the lithium ion secondary battery 40 is increased to a certain pressure or more, the safety valve 47 is separated from the sealing part 412 so as to release the pressure through the opening 413 of the sealing part 412. As a result, the lithium ion secondary battery 40 can be prevented from explosion and the like.

Organic Luminescent Device

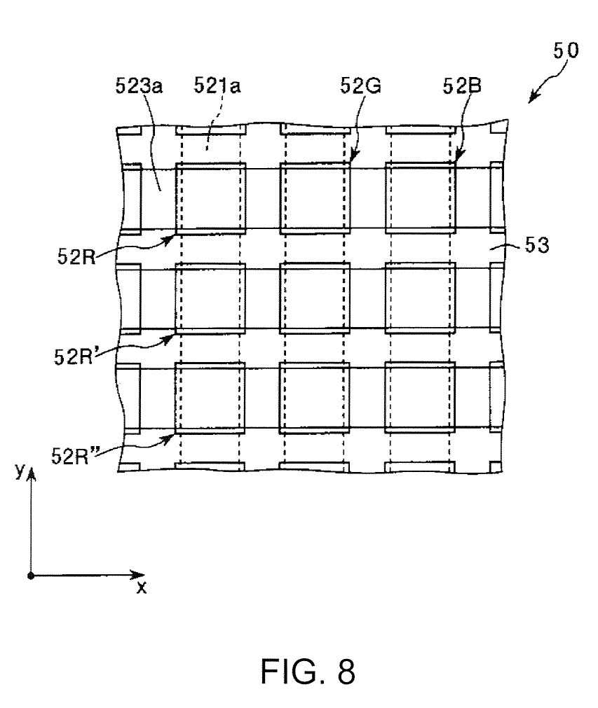

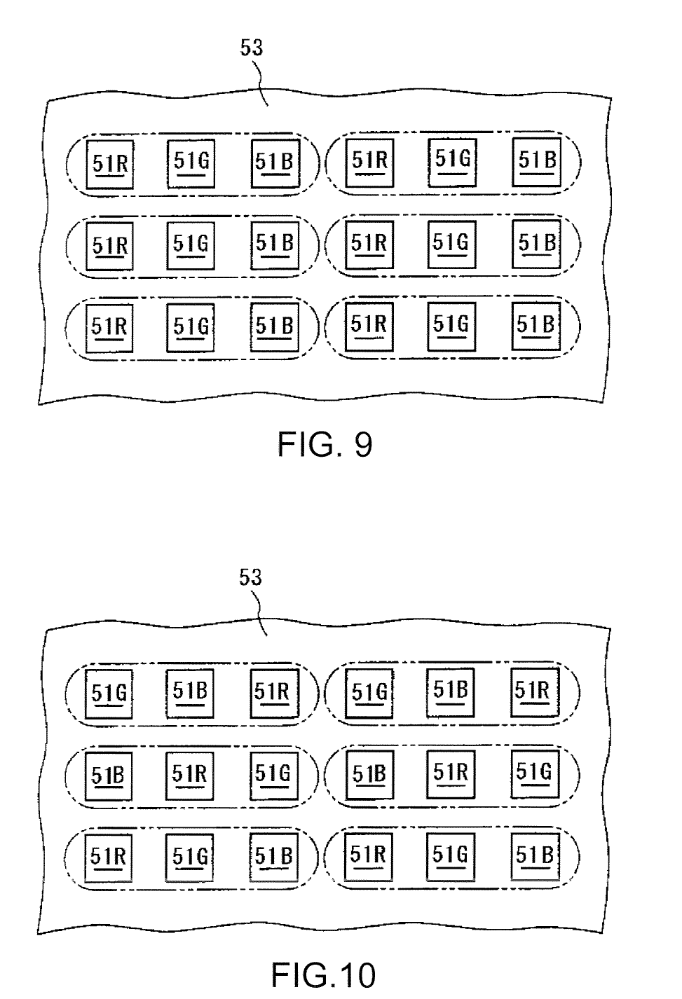

Hereinafter, a preferred embodiment of an organic luminescent device to which the bonding method of the invention is applied will be described. FIG. 7 is a diagram (a cross sectional view) schematically showing the preferred embodiment of the organic luminescent device (a passive matrix type display) to which the bonding method of the invention is applied. FIG. 8 is a plan view explaining a pattern of an anode and a cathode included in the organic luminescent device shown in FIG. 7. FIG. 9 is a plain view explaining an arrangement pattern of organic EL elements included in the organic luminescent device shown in FIGS. 7 and 8. FIG. 10 is a plain view showing another arrangement pattern of the organic EL elements. Note that the top side of the FIGS. 7 to 10 is described as “up” while the bottom side thereof is described as “down” in the following description for simplifying the description.

A passive matrix type display (hereinafter, also simply referred to as a “display”) 50 shown in FIGS. 7 and 8 includes a substrate (a first flexible film) 51 having flexibility, organic EL elements 52R, 52G, and 52B provided on the substrate 51 and respectively emit red (R), green (G), and blue (B) light, partitions 53 partitioning the respective organic EL elements 52 (52R, 52G, and 52B), and a sealing film (a second flexible film) 55 opposed to the substrate 51 and provided so as to seal the organic EL elements 52. The sealing film 55 is bonded to the organic EL element 52 (a cathode 523 described later) and an outer circumference of the substrate 51 with the bonding film 3 interposed therebetween. Hereinafter, a structure of each element will be described.

The substrate 51 has flexibility. The substrate 51 includes the organic EL element 52 provided on an upper surface thereof, and serves as a support body supporting the organic EL element 52. Also, the substrate 51 functions as a sealant hermetically sealing the organic EL element 52 under the organic EL element 52. Since the display 50 according to the present embodiment has a structure such that light is extracted from the sealing film side (the cathode 523 described later) (a top emission type), the substrate 51 is required to have flexibility. However, transparency is not required.

Various kinds of known resin materials are preferably used for the substrate 51, for example. This allows the display 50 to be reduced in weight and improved in flexibility, so that the display 50 can be bent and deformed. In addition, the display 50 can be prevented from being damaged by impact of a drop and the like. In addition, the substrate 51 may be made of a flexible film made of the resin materials described above and treated so as to improve its gas barrier properties. For example, silicon compounds such as SiO, SiO₂, and SiN or inorganic materials such as diamond like carbon (DLC) is formed as a film on a surface of the flexible film by a vapor deposition method, so that the gas barrier properties of the substrate 51 is further improved.

An average thickness of the substrate 51 is not particularly limited and slightly varies depending on its constituent material. However, it is preferably approximately from 10 μm to 2000 μm, and more preferably approximately from 30 μm to 300 μm. As shown in FIG. 7, the adjacent organic EL elements 52 are partitioned by the partition (bank) 53. The partition 53 is provided between an anode 521 and the cathode 523 placed opposed to each other, and has a function of controlling a distance therebetween. The partition 53 includes both ends 531 which are inclined so as to come closer to each other toward the upper side of FIG. 7.

The partitions 53 are formed in a lattice shape as a whole in a plan view (refer to FIG. 8). Accordingly, organic semiconductor layers 522 (the organic EL elements 52) can be provided between the adjacent partitions 53, and the provided organic semiconductor layers 522 are formed in a matrix. The partition 53 is made of an insulating material so as to prevent the adjacent organic semiconductor layers from being electrically coupled to each other.

A constituent material of the partition 53 is selected by considering insulation properties, heat resistance, liquid repellency properties, and adhesiveness of the organic semiconductor 522 and the substrate 51. Specifically, the partition 53 is made of, for example, silicon oxides (inorganic materials) such as SiO₂, and resin materials (organic materials) such as acrylic resin and polyimide resin.

The partition 53 made of the silicon oxides enables insulation properties of the adjacent organic semiconductors 522 to be surely obtained. In addition, since the partition 53 has high processability, the partition 53 with high dimensional accuracy is formed, and consequently, the display 50 with high accuracy is obtained. A shape of openings of the partitions 53 shown in FIG. 8 is a rectangular. However, any shape such as circular, oval, and polygon such as hexagonal may be employed. A height of the partition 53 depends on the total thickness of the anode 521 and the organic semiconductor layer 522. However, it is preferably approximately from 30 nm to 500 nm. With this height, functions of the partition 53 as a partition (a bank) are substantially fulfilled.

Between the partitions 53 provided on an upper surface of the substrate 51 includes the organic EL element 52 (52R, 52G, and 52B). The organic EL element 52 includes the anode 521, the cathode 523, and each organic semiconductor layer 522 (522R, 522G, and 522B) provided between the anode 521 and the cathode 523. That is, the organic EL element 52 has a structure such that the anode 521, the organic semiconductor 522, and the cathode 523 are laminated in this order from the substrate 51 side. The anode 521 is an electrode by which holes are injected into the organic semiconductor layer 522 (in the present embodiment, a hole transport layer 5221). A constituent material (an anode material) of the anode 521 is not particularly limited as long as it has conductivity. However, a material having a large work function and superior conductivity is preferable.

Examples of the constituent material of the anode 521 include indium tin oxide (ITO), fluorine-containing indium tin oxide (FITO), antimony tin oxide (ATO), indium zinc oxide (IZO), aluminum zinc oxide (AZO), tin oxide (SnO₂), zinc oxide (ZnO), fluorine-containing tin oxide (FTO), fluorine-containing indium oxide (FIO), indium oxide (IO), Al, Ni, Co, Au, Pt, Ag, Cu, alloys containing these, and the like. At least one kind of these can be used.

An average thickness of the anode 521 is not particularly limited. However, it is preferably approximately from 10 nm to 200 nm, and more preferably approximately from 50 nm to 150 nm. Further, the anode 521 may be made of a conductive resin material such as polythiophene and polypyrrole. By using the material above, flexibility of the display 50 is improved.

The anode 521 is preferably has light reflectivity. Accordingly, light emitted from an organic light emitting layer 5222 described later is reflected by the sealing film 55 side without being absorbed to the anode 521 side so as to increase an amount of light passing through the sealing film 55 (the cathode 523). As a result, characteristics of the organic EL element 52 such as luminous efficiency and light taking out efficiency are improved.

The anode 521 having such a structure is formed by at least including a surface made of Al, Ni, Co, Ag, or alloys containing these among the anode materials described above. Meanwhile, the cathode 523 is an electrode by which electrons are injected into the organic semiconductor layer 522 (in the present embodiment, an electron transport layer 5223). Since the display 50 has a structure such that light is extracted from the cathode 523 side (a top emission type), the anode 521 is made substantially transparent (transparent and colorless, transparent and colored, or translucent).

As a constituent material (a cathode material) of the cathode 523, materials having a small work function out of materials having superior conductivity are especially preferable so that electron injection efficiency to the electron transport layer 5223 is improved. The cathode 523 having such a structure may be made of, for example, alkali metal materials such as Li, Na, K, Rb, Cs, and Fr, and alkali earth metal materials such as Be, Mg, Ca, Sr, Ba, and Ra. These can be used singly or in a combination of two or more.

If an alloy including metals described above is used as a constituent material of the cathode 523, an alloy including a stable metal such as Ag, Al, and Cu, more specifically, an alloy such as MgAg, AlLi, and CuLi is preferably used. By using these alloys as a constituent material of the cathode 523, the electron injection efficiency to the electron transport layer 5223 and stability of the cathode 523 are improved.

An average thickness of the cathode 523 is not particularly limited. However, it is preferably approximately from 10 nm to 200 nm, and more preferably approximately from 50 nm to 150 nm. The organic semiconductor layer 522 (522R, 522G, and 522B) is provided between the anode 521 and the cathode 523. The organic semiconductor layer 522 includes the hole transport layer 5221, the organic light emitting layer 5222 (5222R, 5222G, 5222B), and the electron transport layer 5223 laminated in this order from the anode 521 side. In addition, in the organic semiconductor layer 522 having such a structure, the hole transport layer 5221, the organic light emitting layer 5222, and the electron transport layer 5223 are made of an organic semiconductor material.

The hole transport layer 5221 has a function of transporting holes injected from the anode 521 to the organic light emitting layer 5222. A constituent material (a hole transport material) of the hole transport layer 5221 includes known hole transport materials. They may be used singly or in a combination of two or more. Further, a hole injection layer for improving the hole injection efficiency from the anode 521 may be provided between the anode 521 and the hole transport layer 5221, for example.

Examples of the constituent material (a hole injection material) of the hole injection layer include copper phthalocyanine, 4,4′,4″-tris(N,N-phenyl-3-methylphenylamino), triphenylamine (m-MTDATA), and the like. The electron transport layer 5223 has a function of transporting electrons injected from the cathode 523 to the organic light emitting layer 5222.

A constituent material (an electron transport material) of the electron transport layer 5223 includes known electron transport materials. They may be used singly or in a combination of two or more. An average thickness of the hole transport layer 5221 and the electron transport layer 5223 is not particularly limited. However, it is preferably approximately from 10 nm to 150 nm, and more preferably approximately from 50 nm to 100 nm. Accordingly, the holes (or the electrons) are efficiently injected from the anode 521 (or the cathode 523) to the organic light emitting layer 522.

Here, when energizing between the anode 521 and the cathode 523 (a voltage is applied), the holes moving in the hole transport layer 5221 are injected to the organic light emitting layer 5222, and the electrons moving in the electron transport layer 5223 are injected to the organic light emitting layer 5222, whereby the holes and the electrons are recombined together in the organic light emitting layer 5222. Then, excitons (exciters) are generated in the organic light emitting layer 5222. The excitons release (emit light) energy (fluorescence or phosphorescence) when returning to the ground state.

As a constituent material (a light emitting material) of the respective organic light emitting layers 5222 (5222R, 5222G, and 5222B), various kinds of known high-molecular materials and low-molecular materials can be used singly or in combination. When the low-molecular material is used as a light emitting material, all of the respective organic light emitting layers 5222R, 5222G, and 5222B are preferably made of the low-molecular light emitting material. On the other hand, when the high-molecular material is used, all of the respective organic light emitting layers 5222R, 5222G, and 5222B are preferably made of the high-molecular light emitting material.

In the light emitting device 50 having such a structure, the anode 521 is a common electrode integrally formed and the neighboring anodes 521 are arranged in one direction (a y direction in FIG. 8) in a linear fashion. The cathodes 523 (common electrodes) are arranged in a direction perpendicular to the one direction (the y direction in FIG. 8) so as to be parallel to each other. That is, each anode 521 is arranged in a stripe manner so as to be parallel in the one direction, and each cathode 523 is arranged in a stripe manner so as to be parallel in the direction perpendicular to the one direction.

Specifically, in FIG. 8, an anode 521a is a common electrode of the organic EL element 52R, an organic EL element 52R′, and an organic EL element 52R″. Additionally, a cathode 523a is a common electrode of the organic EL element 52R, the organic EL element 52G, and the organic EL element 52B. In the display 50, the organic semiconductor layer 522 exists at a position where the anode 521 and the cathode 523 provided in a stripe manner are perpendicular to each other. Then, the anode 521 and the cathode 523 for applying a voltage is selected so that the organic EL element 52 positioning where the anode 521 and the cathode 523 are perpendicular to each other selectively emits light. (For example, in FIG. 8, if the anode 521a and the cathode 523a are electrically coupled, the organic EL element 52R emits light.) In addition, each anode 521 and cathode 523 is respectively coupled to a driver IC that is not shown.

Each of the organic EL elements 52R, 52G, and 52B is arranged in a matrix in a plan view as shown in FIG. 9. A part surrounded by two-dot chain lines (three organic EL elements 52R, 52G, and 52B) forms a single pixel. A pattern of the organic EL elements 52R, 52G, and 52B is not limited to a pattern shown in FIG. 9. It may be a pattern shown in FIG. 10, for example. In FIG. 10, an arrangement order of the organic EL elements 52R, 52G, and 52B is different from that shown in FIG. 9.

The sealing film 55 is provided on the substrate 51 and the organic EL element 52 in a manner covering the organic EL element 52 provided on the substrate 51. Then, the sealing film 55 is bonded to the cathode 523 of the organic EL element 52 with the bonding film 3 interposed therebetween, and is bonded to the substrate 51 with the bonding film 3 interposed therebetween at its outer circumference. The bonding film 3 will be described later. Thus, the organic EL element 52 is sealed between the substrate 51 and the sealing film 55.

The sealing film 55 is made of a material having gas barrier properties. Since the sealing film 55 is made of the material having gas barrier properties, the organic EL element 52 is suppressed or prevented from being deteriorated by moisture absorption and the like. The sealing film 55 may be made of the resin materials for the substrate 51 described above, for example. In addition, the sealing film 55 may be made of a flexible film made of the resin materials described above and treated so as to improve its gas barrier properties. As such the treatment, treatments that can be performed on the substrate 51 are preferably employed, for example.

As described above, the sealing film 55 is respectively bonded to the cathode 523 included in the organic EL element 52 and the outer circumference of the substrate 51 with the bonding film 3 interposed therebetween. That is, the sealing film 55 is bonded to both the cathode 523 and the outer circumference of the substrate 51 by using the bonding method of the invention. In addition, since the bonding film 3 includes regions (the first and the second regions 33 and 34) having different conditions for applying energy when bonding, bonding strength is adjusted for each region. The first region 33 is positioned at an area corresponding to the organic EL element 52 of the bonding film 3 while the second region 34 is positioned at an area corresponding to other than the organic EL element 52 of the bonding film 3. The bonding film 3 positioned at the first region 33 has large bonding strength, so that the sealing film 55 is strongly bonded to both the cathode 523 and the outer circumference of the substrate 51. Meanwhile, the bonding film 3 positioned at the second region 34 has smaller bonding strength compared to the bonding film 3 positioned at the first region 33, and bonds the sealing film 55 and the cathode 523 to each other.

If the bonding strength of the bonding film 3 positioned at the area corresponding to the organic EL element 52 is relatively small, stress between the organic EL element 52 and the bonding film 3, and the organic EL element 52 and the sealing film 55 is reduced when the display 50 is deformed. Thus, the organic EL element 52 is prevented from being damaged by deformation. Meanwhile, by having large bonding strength of the bonding film 3 positioned at the region corresponding to an area other than the organic EL element 52, the sealing film 55 can be surely prevented from being separated. In addition, when the display 50 is deformed, since the sealing film 55 is surely maintained at a region positioned at each partition 53, a degree of expansion and contraction due to the deformation of the organic EL element 52 and the sealing film positioned at the region corresponding to the organic EL element 52 is limited to a certain range. Therefore, stress applied to the organic EL element 52 and the sealing film 55 positioned at the region corresponding to the organic EL element 52 can be easily reduced. Consequently, the display 50 in which the organic EL element 52 and the sealing film 55 are bonded with the bonding film 3 interposed therebetween, separation between the organic EL element 52 and the sealing film 55 hardly occurs even the display 50 is repeatedly bent and deformed.

As a result, regardless of usage environment, the cathode 523 (the organic EL element 52) and the sealing film 55 are strongly bonded for a long period of time with the bonding film 3 interposed therebetween, so that a separation between the cathode 523 and the sealing film 55 can be surely prevented. Therefore, unevenness in a display image caused by wrinkles and the like formed in the sealing film that is separated from the organic EL element can be prevented. The bonding film 3, different from a resin adhesive generally used to seal (bond) a substrate and a sealing film, has high chemical stability which prevents the bonding film 3 from being deteriorated and altered even if it is used in high temperature and humidity environment. Especially, the bonding film 3 has superior heat resistance. Therefore, when the organic EL element 52 (the organic light emitting layer 5222) is continuously light emitted, the organic EL element 52 becomes to high temperature. However, the bonding film 3 is surely prevented from being altered and deteriorated by the heat.

A thickness of the bonding film 3 is extremely thinner than that of an adhesive layer (approximately several dozen μm) formed by drying and hardening a resin adhesive, and has extremely small unevenness in thickness. Accordingly, the sealing film 55 is provided on an upper surface of the organic EL element 52 and the partition 53 in a state that a surface of the sealing film 55 is flat and smooth. As described above, since the display 50 has a structure such that light is extracted from the sealing film 55 side (a top emission type), if the surface of the sealing film 55 has concavity and convexity, unevenness in a display image is caused. However, in the display 50, such a problem is surely prevented.

Further, the sealing film 55 is bonded to the outer circumference of the substrate 51 with the bonding film 3 described above interposed therebetween. Accordingly, the adhesiveness between the substrate 51 and the sealing film 55 is improved, whereby the display 50 has superior durability. Furthermore, airtight properties of a space sealed with the substrate 51 and the sealing film 55 is improved, resulting in preventing the organic EL element 52 from being deteriorated and altered by moisture absorption and the like.

Hereinabove, the bonding method and the bonded body of the invention have been described with reference to the drawings, but the embodiments of the invention are not limited to these. For example, for the bonding method of the invention, at least one other arbitrarily intended step may be added according to need. In addition, in the embodiments above, energy is applied to each region of the bonding film under different conditions. However, the energy may be applied to an entire surface of the bonding film under the same condition, and adhesiveness of the bonding film may be adjusted by the amount of applied energy.

What is claimed is:

1. A bonding method, comprising:
forming a film including silicone to at least one of a first substrate and a second substrate; and
developing adhesiveness on a surface of the film by applying energy to the film so as to obtain a bonded body obtained by bonding the first substrate and the second substrate each other with the film interposed between the first substrate and the second substrate, wherein bonding strength of the film is adjusted by setting a condition for applying the energy.

2. The bonding method according to claim 1, wherein the condition is set by adjusting an amount of energy applied to the film.

3. The bonding method according to claim 2, wherein the energy is applied by at least one out of irradiating the film with an energy ray, heating the film, and applying a pressure on the film so as to set the condition.

4. The bonding method according to claim 3, wherein the energy is applied by irradiating the film with the energy ray, the energy ray is an ultraviolet ray having a wavelength from 126 nm to 300 nm.

5. The bonding method according to claim 3, wherein the energy is applied in an ambient atmosphere.

6. The bonding method according to claim 1, wherein the energy is applied to a first region of the film and a second region of the film that is different from the first region under a different condition so that at the first region and the second region have different bonding strength.

7. The bonding method according to claim 6, wherein the energy is applied to the film multiple times.

8. The bonding method according to claim 6, further comprising:
selectively applying the energy to the first region;
bringing the first substrate and the second substrate into contact with each other with the film interposed between the first substrate and the second substrate; and
applying the energy to the first region and the second region.

9. The bonding method according to claim 6, further comprising:
applying the energy to the film positioned at the first region and the second region;
bringing the first substrate and the second substrate into contact with each other with the film interposed between the first substrate and the second substrate; and
selectively applying energy to the film positioned at the first region.

10. The boning method according to claim 1, wherein the silicone material includes a silanol group.

11. The boning method according to claim 1, wherein the silicone material includes a phenyl group bonded to a silicon atom having a silanol group.

12. The bonding method according to claim 1, wherein bringing the first substrate and the second substrate into contact with each other with the film interposed between the first substrate and the second substrate after the energy is applied to the film so as to develop adhesiveness on a surface of the film.

13. The bonding method according to claim 1, wherein the bonded body is obtained by applying the energy to the film after bringing the first substrate and the second substrate into contact with each other with the film interposed between the first substrate and the second substrate.

14. The bonding method according to claim 1, wherein the film is formed by a liquid coating film by applying a discharged liquid material droplet, then by drying the liquid coating film.

15. The bonding method according to claim 1, wherein an average thickness of the film is 10 nm to 10000 nm.

16. The bonding method according to claim 1, wherein at least a part of the first substrate and the second substrate contacting the film is made of silicon, metal, or glass as a main material.

17. The bonding method according to claim 1, wherein a surface of the first substrate and the second substrate contacting the film is surface-treated with a treatment that includes a plasma treatment or an ultraviolet (UV) radiation treatment.

18. A bonded body, comprising:
the first substrate and the second substrate are bonded by the bonding method according to claim 1.
